(19) United States
(12) Patent Application Publication
(10) Pub. No.: US 2010/0173610 A1
(43) Pub. Date: Jul. 8, 2010

(54) ACCESS STRATUM SECURITY CONFIGURATION FOR INTER-CELL HANDOVER

(75) Inventors: Masato Kitazoe, Tokyo (JP); Nathan Edward Tenny, Poway, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/651,659

(22) Filed: Jan. 4, 2010

Related U.S. Application Data
(60) Provisional application No. 61/142,585, filed on Jan. 5, 2009.

(51) Int. Cl. H04W 12/04

(52) U.S. Cl. 455/411

(57) ABSTRACT

Systems and methodologies are described that handle security activation during handover in a wireless network. A new access stratum (AS) key can be provided to a serving access point (and a related wireless device) before and/or while preparing a target access point during an inter-cell handover. The serving access point can receive the new AS key and provide it to the target access point as part of handover preparation. The serving access point can then initiate inter-cell handover of the related wireless device indicating that the wireless device can utilize a new AS key before the serving access point has an opportunity to activate the new AS key with the wireless device. The wireless device can subsequently perform a random access procedure to the target access point and/or establish a connection therewith by transmitting other messages using the new AS key.

### CROSS-REFERENCE

This application claims the benefit of U.S. Provisional Application Ser. No. 61/142,585, filed Jan. 5, 2009, and entitled “SECURITY HANDLING AT ACCESS STRATUM,” the entirety of which is incorporated herein by reference.

### BACKGROUND

I. Field

The present disclosure relates generally to wireless communications and more specifically to handling access stratum security during inter-cell handover.

II. Background

Wireless communication systems are widely deployed to provide various types of communication content such as, for example, voice, data, and so on. Typical wireless communication systems may be multiple-access systems capable of supporting communication with multiple users by sharing available system resources (e.g., bandwidth, transmit power, . . . ). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP long term evolution (LTE), ultra mobile broadband (UMB), etc.

Generally, wireless multiple-access communication systems may simultaneously support communication for multiple mobile devices. Each mobile device may communicate with one or more access points (e.g., base stations, femtocells, picocells, relay nodes, and/or the like) via transmissions on forward and reverse links. The forward link (or downlink) refers to the communication link from access points to mobile devices, and the reverse link (or uplink) refers to the communication link from mobile devices to access points. Further, communications between mobile devices and access points may be established via single-input single-output (SISO) systems, multiple-input single-output (MISO) systems, multiple-input multiple-output (MIMO) systems, and so forth. In addition, mobile devices can communicate with other mobile devices (and/or access points with other access points) in peer-to-peer wireless network configurations.

Mobile devices can be authenticated with an underlying core network upon initiating communications with an access point. This can include communicating with the core network via access point over a non-access stratum (NAS) layer to obtain an access stratum (AS) key (e.g., using an authentication and key agreement (AKA)/NAS security mode command (SMC) and/or the like). The core network can additionally provision the AS key to the access point. Subsequently, the mobile device and access point can communicate using the new AS key. For example, this can include using the AS key for verification purposes, to encrypt and/or decrypt communications, cipher and/or decipher communications, and/or the like. In one example, the access point can notify the mobile device when the new AS key can be utilized for subsequent communications.

In addition, mobile devices can handover communications inter-cell among various access points (and/or related cells thereof) to facilitate seamless access to the underlying core network. In one example, the mobile device can measure communications metrics of neighboring access points and provide a measurement report to the serving access point. If one or more access points or cells thereof are more suitable for mobile device communication according to the measurement report, the serving access point can prepare the one or more access points for receiving mobile device communications and facilitate handover thereto.

### SUMMARY

The following presents a simplified summary of various aspects of the claimed subject matter in order to provide a basic understanding of such aspects. This summary is not an extensive overview of all contemplated aspects, and is intended to neither identify key or critical elements nor delineate the scope of such aspects. Its sole purpose is to present some concepts of the disclosed aspects in a simplified form as a prelude to the more detailed description that is presented later.

In accordance with one or more embodiments and corresponding disclosure thereof, various aspects are described in connection with facilitating handling a new access stratum (AS) key available at a serving access point before and/or while preparing a target access point during an inter-cell handover. For example, the serving access point can receive the new AS key and provide it to the target access point as part of handover preparation. Subsequently, the serving access point can initiate inter-cell handover at the related wireless device indicating that the wireless device can utilize a new AS key. The wireless device can then perform a random access procedure to the target access point and establish a connection therewith using the new AS key. For example, the wireless device can have previously received the new AS key from a core network.

According to related aspects, a method is provided that includes generating a new AS key during a security control procedure with a wireless network component and transmitting a communication to the serving access point that initiates an inter-cell handover with a target access point using a security context related to the old AS key. The method further includes applying a disparate security context related to the new AS key to one or more communications related to completing the inter-cell handover with the target access point.

Another aspect relates to a wireless communications apparatus. The wireless communications apparatus can include at least one processor configured to obtain a new AS key during a security control procedure and provide a communication to a serving access point relating to inter-cell handover to a target access point using a security context based on an old AS key. The at least one processor is further configured to apply a disparate security context related to the new AS key to one or more communications for the target access point related to completing an inter-cell handover to the target access point. The wireless communications apparatus also comprises a memory coupled to the at least one processor.

Yet another aspect relates to an apparatus. The apparatus includes means for performing a security control procedure with a wireless network component to receive a new AS key and means for transmitting a communication to a serving access point to initiate an inter-cell handover with a target access point using a security context based on an old AS key. The apparatus also includes means for applying a disparate security context related to the new AS key to one or more communications related to completing the inter-cell handover with the target access point.

Still another aspect relates to a computer program product, which can have a computer-readable medium including code for causing at least one computer to generate a new AS key based at least in part on a security control procedure with a wireless network component and code for causing the at least one computer to transmit a communication to a serving access point to initiate an inter-cell handover with a target access point using a security context based on an old AS key. The computer-readable medium can also comprise code for causing the at least one computer to apply a disparate security context related to the new AS key to one or more communications related to completing the inter-cell handover with the target access point.

Moreover, an additional aspect relates to an apparatus including an authentication and key agreement (AKA)/non-access stratum (NAS) security mode command (SMC) component that performs a security control procedure with a wireless network component to receive a new AS key and a measurement report component that transmits a communication to a serving access point to initiate an inter-cell handover with a target access point using an security context based on an old AS key. The apparatus can further include a security context applying component that associates a disparate security context related to the new AS key to one or more communications related to completing the inter-cell handover with the target access point.

According to another aspect, a method is provided that includes receiving a new AS key related to communicating with a wireless device and determining to perform a handover of communications of the wireless device to a target access point. The method further includes transmitting a connection reconfiguration message to the wireless device that indicates a key change to the new AS key to complete the handover of communications of the wireless device to the target access point.

Another aspect relates to a wireless communications apparatus. The wireless communications apparatus can include at least one processor configured to obtain a new AS key related to communicating with a wireless device and decide to perform a handover of communications of the wireless device to a target access point. The at least one processor is further configured to provide a connection reconfiguration message to the wireless device to complete the handover of communications of the wireless device to the target access point, wherein the connection reconfiguration message specifies a key change to the new AS key or a disparate key stream identifier. The wireless communications apparatus also comprises a memory coupled to the at least one processor.

Yet another aspect relates to an apparatus. The apparatus includes means for receiving a new AS key for communicating with a wireless device and means for determining to perform a handover of communications of the wireless device to a target access point. The apparatus also includes means for transmitting a connection reconfiguration message to the wireless device that indicates a key change to the new AS key to complete the handover of communications of the wireless device to the target access point.

Still another aspect relates to a computer program product, which can have a computer-readable medium including code for causing at least one computer to receive a new AS key related to communicating with a wireless device and code for causing the at least one computer to determine to perform a handover of communications of the wireless device to a target access point. The computer-readable medium can also comprise code for causing the at least one computer to transmit a connection reconfiguration message to the wireless device that indicates a key change to the new AS key to complete the handover of communications of the wireless device to the target access point.

Moreover, an additional aspect relates to an apparatus including a new key receiving component that obtains a new AS key for communicating with a wireless device and a handover determining component that decides to perform a handover of communications of the wireless device to a target access point. The apparatus can further include a key change indicating component that transmits a connection reconfiguration message to the wireless device that indicates a key change to the new AS key to complete the handover of communications of the wireless device to the target access point.

In accordance with yet another aspect, a method is provided that includes receiving a new AS key and an old AS key related to communicating with a wireless device from a serving access point during a handover preparation and performing a random access procedure with the wireless device to participate in a handover related to the handover preparation.

Another aspect relates to a wireless communications apparatus. The wireless communications apparatus can include at least one processor configured to obtain a new AS key and an old AS key from a serving access point during a handover preparation related to communicating with a wireless device. The at least one processor is further configured to perform a random access procedure with the wireless device to facilitate receiving wireless device communications in a handover from the serving access point related to the handover preparation. The wireless communications apparatus also comprises a memory coupled to the at least one processor.

Yet another aspect relates to an apparatus. The apparatus includes means for receiving a new AS key and an old AS key related to communicating with a wireless device from a serving access point during a handover preparation. The apparatus also includes means for performing a random access procedure with the wireless device to participate in a handover related to the handover preparation.

Still another aspect relates to a computer program product, which can have a computer-readable medium including code for causing at least one computer to receive a new AS key and an old AS key related to communicating with a wireless device from a serving access point during a handover preparation. The computer-readable medium can also comprise code for causing the at least one computer to perform a random access procedure with the wireless device to participate in a handover related to the handover preparation.

Moreover, an additional aspect relates to an apparatus including a new key obtaining component that receives a new AS key and an old AS key related to communicating with a wireless device from a serving access point during a handover preparation. The apparatus can further include a device communicating component that performs a random access procedure with the wireless device to participate in a handover related to the handover preparation.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed, and the described embodiments are intended to include all such aspects and their equivalents.

### BRIEF DESCRIPTION OF THE DRAWINGS

FIG. 1 is a block diagram of a system for handing over wireless device communications among access points.

FIG. 2 is an illustration of an example communications apparatus for employment within a wireless communications environment.

FIG. 3 illustrates a block diagram of an example system for handling security key changes during handover.

FIG. 4 illustrates a block diagram of an example wireless communications network over which security keys are activated as part of handover.

FIG. 5 illustrates a block diagram of an example wireless communications network over which security keys are activated as part of handover following radio link failure.

FIG. 6 illustrates a block diagram of an example wireless communications network over which security keys are activated following handover failure.

FIG. 7 illustrates a block diagram of an example wireless communications network that activates a new security key after re-establishing a failed connection.

FIG. 8 is a flow diagram of an example methodology that applies security based on a new access stratum (AS) key to communications with a target access point following handover.

FIG. 9 is a flow diagram of an example methodology that indicates key change to a wireless device in performing inter-cell handover of communications of the wireless device.

FIG. 10 is a flow diagram of an example methodology that prepares a target access point for handover.

FIG. 11 is a flow diagram of an example methodology that interprets communications from a wireless device following handover.

FIG. 12 is a flow diagram of an example methodology that interprets communications from a wireless device following handover using a received security context.

FIG. 13 is a block diagram of an example apparatus that facilitates communicating with a target access point using a new AS key following handover.

FIG. 14 is a block diagram of an example apparatus that provisions a target access point with security information related to a wireless device during handover preparation.

FIG. 15 is a block diagram of an example apparatus that interprets communications from a wireless device according to a new AS key following handover.

FIGS. 16-17 are block diagrams of example wireless communication devices that can be utilized to implement various aspects of the functionality described herein.

FIG. 18 illustrates an example wireless multiple-access communication system in accordance with various aspects set forth herein.

FIG. 19 is a block diagram illustrating an example wireless communication system in which various aspects described herein can function.

### DETAILED DESCRIPTION

Various aspects of the claimed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

As used in this application, the terms “component,” “module,” “system,” and the like are intended to refer to a computer-related entity, either hardware, firmware, a combination of hardware and software, software, or software in execution. For example, a component can be, but is not limited to being, a process running on a processor, an integrated circuit, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

Furthermore, various aspects are described herein in connection with a wireless terminal and/or a base station. A wireless terminal can refer to a device providing voice and/or data connectivity to a user. A wireless terminal can be connected to a computing device such as a laptop computer or desktop computer, or it can be a self contained device such as a personal digital assistant (PDA). A wireless terminal can also be called a system, a subscriber unit, a subscriber station, mobile station, mobile, remote station, access point, remote terminal, access terminal, user terminal, user agent, user device, or user equipment (UE). A wireless terminal can be a subscriber station, wireless device, cellular telephone, PCS telephone, cordless telephone, a Session Initiation Protocol (SIP) phone, a wireless local loop (WLL) station, a personal digital assistant (PDA), a handheld device having wireless connection capability, or other processing device connected to a wireless modem. A base station (e.g., access point or Evolved Node B (eNB)) can refer to a device in an access network that communicates over the air-interface, through one or more sectors, with wireless terminals. The base station can act as a router between the wireless terminal and the rest of the access network, which can include an Internet Protocol (IP) network, by converting received air-interface frames to IP packets. The base station also coordinates management of attributes for the air interface.

Moreover, various functions described herein can be implemented in hardware, software, firmware, or any combination thereof. If implemented in software, the functions can be stored on or transmitted over as one or more instructions or code on a computer-readable medium. Computer-readable media includes both computer storage media and communication media including any medium that facilitates transfer of a computer program from one place to another. A storage media can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc (BD), where disks usually reproduce data magnetically and discs reproduce data optically with lasers. Combinations of the above should also be included within the scope of computer-readable media.

Various techniques described herein can be used for various wireless communication systems, such as Code Division Multiple Access (CDMA) systems, Time Division Multiple Access (TDMA) systems, Frequency Division Multiple Access (FDMA) systems, Orthogonal Frequency Division Multiple Access (OFDMA) systems, Single Carrier FDMA (SC-FDMA) systems, and other such systems. The terms “system” and “network” are often used herein interchangeably. A CDMA system can implement a radio technology such as Universal Terrestrial Radio Access (UTRA), CDMA2000, etc. UTRA includes Wideband-CDMA (W-CDMA) and other variants of CDMA. Additionally, CDMA2000 covers the IS-2000, IS-95 and IS-856 standards. A TDMA system can implement a radio technology such as Global System for Mobile Communications (GSM). An OFDMA system can implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is an upcoming release that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Further, CDMA2000 and UMB are described in documents from an organization named “3rd Generation Partnership Project 2” (3GPP2).

Various aspects will be presented in terms of systems that can include a number of devices, components, modules, and the like. It is to be understood and appreciated that the various systems can include additional devices, components, modules, etc. and/or can not include all of the devices, components, modules etc. discussed in connection with the figures. A combination of these approaches can also be used.

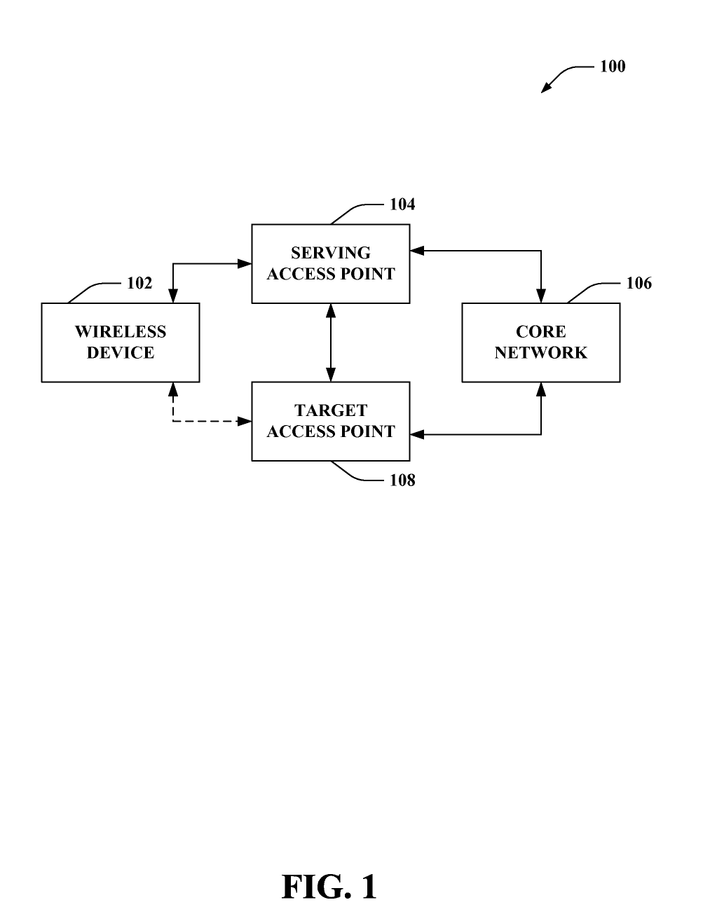

Referring now to the drawings, FIG. 1 illustrates an example wireless network 100 that facilitates handing over wireless device communications among access points. Wireless network 100 includes a wireless device 102 that communicates with a disparate device, such serving access point 104, to receive access to a core network 106. Wireless device 102 can be a mobile device, such as a UE, a portion thereof, and/or substantially any device that receives access to a wireless network. In addition, serving access point 104 and a target access point 108 can be macrocell access points, femtocell or picocell access points, eNBs, mobile base stations, portions thereof, and/or substantially any devices that provide access to a wireless network, such as core network 106. In this example, wireless device 102 communications can be handed over from serving access point 104 to target access point 108.

For example, wireless device 102 can receive access to core network 106 from serving access point 104. Wireless device 102 can periodically measure neighboring access points to determine whether to handover communications to a disparate access point. For instance, wireless device 102 can travel throughout a region reselecting disparate access points for communication when desirable. In one example, wireless device 102 can measure one or more communications metrics of the neighboring access points and provide a measurement report to serving access point 104. In this example, serving access point 104 determines whether to perform handover to one or more access points in the measurement report based on the communication metrics (e.g., as compared to similar metrics of serving access point 104).

In the depicted example, serving access point 104 can decide to handover wireless device 102 communications to target access point 108. Serving access point 104 can, thus, prepare the target access point 108 for handover providing context parameters, security parameters, and/or the like, relating to the wireless device 102. Serving access point 104 can communicate with target access point 108 in this regard over a backhaul link, over the air, and/or the like. Following preparation, serving access point 104 can initiate handover at wireless device 102, and the wireless device 102 can begin communicating with target access point 108 to access the core network 106.

For example, upon initiating communications with core network 106 via serving access point 104, wireless device 102 can receive an access stratum (AS) key from one or more core network 106 components, such as a mobility management entity (MME). This can be part of an authentication and key agreement (AKA)/non-access stratum (NAS) security mode command (SMC) or similar security control procedure with the core network 106. Core network 106 can additionally provide the AS key to serving access point 104. Serving access point 104 can notify the wireless device 102 that it has received the key, such as by performing an intra-cell handover with the wireless device 102. For example, as part of the intra-cell handover, serving access point 104 can transmit a connection reconfiguration message to the wireless device 102 setting a key change indicator variable in the message to true. Based on receiving the indicator, wireless device 102 can utilize the AS key in subsequently communicating with the serving access point 104 (e.g., by indicating the AS key within communications and/or encrypting or ciphering communications with the AS key).

Wireless device 102, serving access point 104, and/or core network 106 can initiate re-keying to provide a new key to wireless device 102 and serving access point 104 (e.g., as part of a security renewal policy, upon restoring a lost or low quality connection, upon request from one or more network devices, etc.). In one example, as described, wireless device 102 can transmit a measurement report to serving access point 104, and serving access point 104 can determine to handover wireless device 102 communications to target access point 108. A re-keying for wireless device 102, however, can be initiated during the handover process. For example, wireless device 102 can perform an AKA/NAS SMC following transmitting the measurement report. Core network 106, however, can fail to provide the new AS key to serving access point 104 before serving access point 104 prepares target access point 108 for the handover. In this example, serving access point 104 prepares target access point 108 with the old AS key and transmits a connection reconfiguration message to the wireless device 102 to complete handover. In this regard, the connection reconfiguration message can set a key change indicator to false so wireless device 102 continues using the old AS key when communicating with target access point 108. Thus, wireless device 102 can perform a random access procedure, confirm connection reconfiguration, and/or the like with target access point 108 using the old AS key.

Subsequently, serving access point 104 can receive the new AS key from the core network 106 and can indicate a failure for receiving the AS key. In response, core network 106 can provide the new AS key to target access point 108. In one example, core network 106 can determine to send the new AS key to the target access point 108 based at least in part on the failure from serving access point 104, which can indicate that a triggered handover resulted in the failure. In another example, serving access point 104 can identify the target access point 108 in the failure message. Target access point 108 can perform an intra-cell handover to wireless device 102, as described above, to begin using the new AS key. Thus, setting the key change indicator to false allows wireless device 102 to continue communicating with core network 106 following handover until the target access point 108 receives and activates the new AS key.

In another example, however, serving access point 104 can receive a new AS key before preparing the target access point 108 for handover. In a further example, serving access point 104 can receive the new AS key, receive a measurement report from wireless device 102, and prepare target access point 108 for handover before it has the opportunity to activate the new AS key with wireless device 102. In this example, serving access point 104 can prepare the target access point 108 for handover specifying the old AS key, and/or related security parameters, along with the new AS key. Subsequently, serving access point 104 can complete handover by transmitting the connection reconfiguration message to the wireless device 102, which specifies the key change indicator as true. In this regard, wireless device 102 can perform random access, connection reconfiguration procedures, etc. with target access point 108 using the new AS key. In one example, wireless device 102 can be communicating in a discontinuous receive mode (DRX) such that it receives communications from serving access point 104 only during on-durations (durations where wireless device 102 enables receiving). Thus, in this example, wireless device 102 can perform re-keying and transmit a measurement report to serving access point 104 before serving access point 104 has the opportunity to perform intra-cell handover to activate the new AS key.

In addition, for example, serving access point 104 can provide the key change indicator value to target access point 108 during a handover preparation procedure. For instance, in the event that target access point 108 transmits a connection reconfiguration message to wireless device 102 instead of serving access point 104, it can indicate the key change via the key change indicator value. This can be the case, for example, where serving access point 104 loses connection with wireless device 102, handover procedure fails, and/or the like. In another example, serving access point 104 can provide a key stream identifier (KSI) of the new AS key to the target access point 108 instead of the key change indicator, and can additionally provide the KSI to the wireless device 102 (e.g., in the connection reconfiguration message). In this example, wireless device 102 can apply the AS key associated with the KSI in communications for target access point 108, and target access point 108 can accordingly interpret communications from wireless device 102 based at least in part on the KSI.

Furthermore, in an example, the radio link between serving access point 104 and target access point 108 can fail before wireless device 102 receives the reconfiguration message to complete handover. In another example, handover can fail at the wireless device 102 after receiving the reconfiguration message. To recover from either (or both) examples, serving access point 104 can provide a security context related to the old AS key and/or a security context related to the new AS key (e.g., a short message authentication code for integrity check (MAC-I) or related value) to target access point 108. The MAC-I, for example, can be related to an old or new security configuration based on the old or new AS key, respectively, and thus can be generated based on the appropriate key. Target access point 108 can utilize the security context to authenticate or otherwise appropriately interpret messages from wireless device 102 (e.g., depending on the keying behavior of wireless device 102), for example. Where target access point 108 is provisioned with a security context based on the old AS key, it can perform an intra-cell handover with wireless device 102 upon establishing radio connection therewith to re-key to the new AS key.

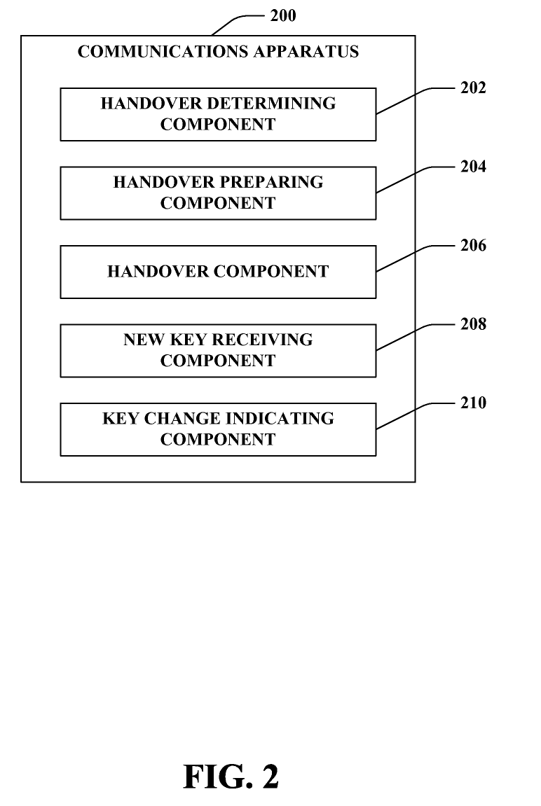

Referring next to FIG. 2, a communications apparatus 200 that can participate in a wireless communications network is illustrated. The communications apparatus 200 can be an access point (e.g., a macrocell, femtocell, or picocell access point, a mobile access point, eNB, relay node, and/or the like), a mobile device (e.g., a UE, modem or other tethered device, and/or the like), a portion thereof, or substantially any device that receives communications in a wireless network. The communications apparatus 200 can include a handover determining component 202 that decides whether to handover wireless device communications to a disparate communications apparatus (not shown), a handover preparing component 204 that can communicate with the disparate communications apparatus in preparation for handover of wireless device communications, a handover component 206 that can complete handover of wireless device communications to the disparate communications apparatus, a new key receiving component 208 that acquires a new AS key related to communicating with the wireless device, and a key change indicating component 210 that activates a new AS key for use with the wireless device.

According to an example, handover determining component 202 can decide whether to handover wireless device communications to the disparate communications apparatus. In one example, this can be based at least in part on a measurement report, which can be received from the wireless device and can include communications metrics related to one or more neighboring communications apparatuses, such as throughput, SNR, geographic distance, and/or the like. For example, handover determining component 202 can decide to handover communications based on comparing communications metrics in the measurement report to similar metrics related to wireless device communication with the communications apparatus 200. When handover determining component 202 decides to handover communications to the disparate communications apparatus, handover preparing component 204 can communicate wireless device related parameters (e.g., context, identification, authentication parameters, etc.) to the disparate communications apparatus. Handover component 206 can subsequently transmit a connection reconfiguration message to the wireless device to cause the wireless device to handover communications to the disparate communications apparatus.

As described, for example, new key receiving component 208 can obtain a new AS key for the wireless device. For example, new key receiving component 208 can receive the new AS key from a core network component (not shown), such as an MME (e.g., over a backhaul link). Upon receiving the new AS key, key change indicating component 210 can specify a key change (e.g., by setting a key change indicator value, indicating a KSI, and/or the like) in a connection reconfiguration message, and handover component 206 can transmit the connection reconfiguration message to the wireless device to perform an intra-cell handover activating the new AS key for subsequent use by the communications apparatus 200 and the wireless device.

In one example, new key receiving component 208 can receive the new AS key before or during a handover procedure described above. Where new key receiving component 208 obtains the new AS key before or during the handover procedure, and indeed before completing handover with the wireless device, key change indicating component 210 can set a key change indicator in the connection reconfiguration message that facilitates completing handover to false. Thus, handover component 206 transmits the connection reconfiguration message to the wireless device, which can continue utilizing the old AS key with the disparate communications apparatus, as described.

Where new key receiving component 208 obtains the new AS key before or while handover preparing component 204 is preparing the disparate communications apparatus for handover, however, handover preparing component 204 can provision the disparate communications apparatus with the new AS key (e.g., in addition to the old key). In this regard, key change indicating component 210 can set the key change indicator value in the connection reconfiguration message to a true value, and handover component 206 can transmit the connection reconfiguration message to the wireless device. In one example, the wireless device can be operating in a DRX mode where it can freely transmit to the communications apparatus 200, but communications apparatus 200 must wait until specified periods of time to transmit to the wireless device. Thus, for example, new key receiving component 208 can obtain a new AS key for the wireless device, handover determining component 202 can decide to handover wireless device communications to the disparate communications apparatus, and handover preparing component 204 can prepare the disparate communications apparatus for handover all before handover component 206 has an opportunity to complete handover by transmitting the connection reconfiguration message to the wireless device. Thus, handover preparing component 204, where new key receiving component 208 has previously received the new AS key, can provide the new AS key to the disparate communications apparatus in preparing it for handover.

It is to be appreciated, however, that radio link failure, handover failure, and/or the like can occur during the handover procedure. In this regard, in one example, handover preparing component 204 can additionally or alternatively provide a security context related to the old AS key (e.g., a short MAC-I, etc.) and/or a security context related to the new AS key to the disparate communications apparatus during handover preparation. In this regard, upon failure, the wireless device can communicate with the disparate communications apparatus using at least one of the two security contexts, and the disparate communications apparatus can accordingly interpret communications from the wireless device.

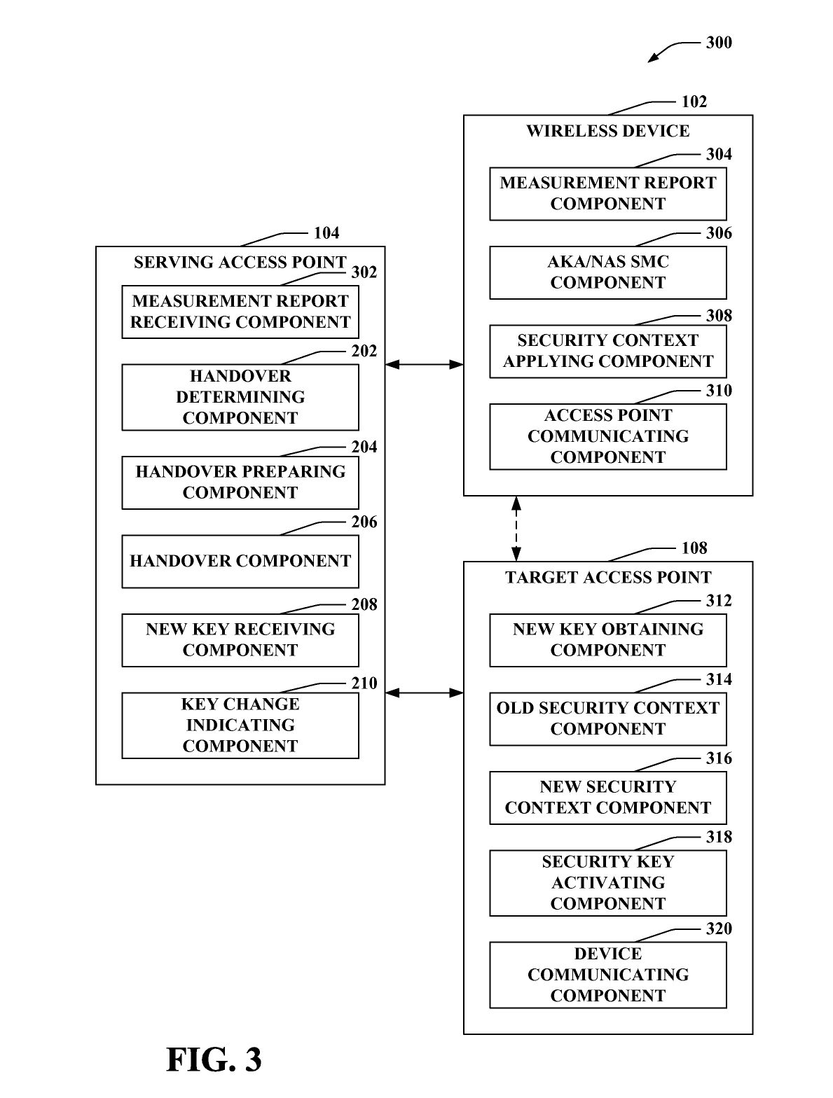

Now referring to FIG. 3, illustrated is a wireless communications system 300 that facilitates handling security configuration during inter-cell handover. System 300 includes a wireless device 102 that communicates with a serving access point 104 to receive access to a wireless network (not shown). As described, the wireless devices 102 can be substantially any type of base station, mobile device (including not only independently powered devices, but also modems, for example), UE, a portion thereof, etc., that receives access to a wireless network. Serving access point 104 and target access point 108, as described, can be macrocell access points, femtocell access points, picocell access points, relay nodes, mobile base stations, a portion thereof, and/or substantially any device that provides access to a wireless network. Moreover, system 300 can be a MIMO system and/or can conform to one or more wireless network system specifications (e.g., EV-DO, 3GPP, 3GPP2, 3GPP LTE, WiMAX, etc.). In addition, the components and functionalities of serving access point 104 can be present in target access point 108 and vice versa, for example, to provide similar functionality.

Serving access point 104 comprises a measurement report receiving component 302 that obtains a measurement report from a wireless device regarding communications metrics of one or more neighboring access point with respect to the wireless device, a handover determining component 202 that decides whether to handover wireless device communications to a neighboring access point in the measurement report based on its associated communication metrics, a handover preparing component 204 that provisions the neighboring access point with information regarding the wireless device (e.g., context, security or authentication parameters, etc.) to facilitate handover, a handover component 206 that transmits a connection reconfiguration message to the wireless device to complete handover, a new key receiving component 208 that obtains a new AS key for the wireless device (e.g., from the core network), and a key change indicating component 210 that activates the new AS key for use with the wireless device.

Wireless device 102 includes a measurement report component 304 that can create and transmit a measurement report relating to communications metrics of neighboring access points, or other handover related communications, to a serving access point, an AKA/NAS SMC component 306 that performs a security control procedure, such as an AKA/NAS SMC, with a core network to receive a new AS key, a security context applying component 308 that associates a security context to data before transmitting to one or more access points, and an access point communicating component 310 that transmits data to and receives data from one or more access points. Target access point 108 can include a new key obtaining component 312 that receives a new AS key for a wireless device from a serving access point, an old security context component 314 that obtains and/or generates a security context based on an old AS key from a serving access point, a new security context component 316 that receives or generates a security context based on a new AS key for a wireless device, a security key activating component 318 that can notify a wireless device that it can utilize a new security key in communicating with target access point 108, and a device communicating component 320 that transmits data to or receives data from one or more wireless devices.

According to an example, measurement report component 304 can measure neighboring access points to obtain related communications metrics, such as SNR, throughput, location, services offered, restricted association parameters, and/or the like, and can transmit the measurement report to serving access point 104. In another example, measurement report component 304 can transmit other communications to serving access point 104 that can initiate handover. In either case, security context applying component 308 can apply a security context based on the old AS key to the communication from measurement report component 304, and access point communicating component 310 can transmit the communication to serving access point 104. Measurement report receiving component 302 can obtain the measurement report or other communications, and handover determining component 202 can decide whether to handover communications of wireless device 102 to one or more neighboring access points based on the communication (e.g., the neighboring access points can be enumerated in the measurement report). For example, handover determining component 202 can discern whether communications metrics of one or more of the neighboring access points are more desirable (e.g., improved SNR, enhanced services offered, etc.) than serving access point 104, and if so, handover determining component 202 can decide to initiate handover to the neighboring access point.

In this example, handover preparing component 204 can transmit information regarding wireless device 102 to target access point 108, such as context information, security or authentication parameters, and/or the like. Handover component 206 can subsequently complete handover by transmitting a connection reconfiguration message to wireless device 102. Wireless device 102 can then communicate with the target access point 108 (e.g., via access point communicating component 310, which can transmit communications as described) to complete the handover. In addition, security context applying component 308 can associate a security context to data communicated to target access point 108 (e.g., by wrapping the data in a context, applying an encryption, ciphering, or other modification based on a security context, which can relate to an AS key, and/or the like). Device communicating component 320 can interpret communications from the wireless device 102, in this example, according to the security context, as described.

In an example, as described, AKA/NAS SMC component 306 can perform an AKA/NAS SMC or a disparate security control procedure with a core network (not shown) and can accordingly generate a new AS key for application to subsequent communications in the wireless network. The core network component (e.g., a MME or similar component) can also provide a new related AS key to serving access point 104. New key receiving component 208 can similarly receive the new AS key. As described, for example, measurement report component 304 can generate and transmit a measurement report to serving access point 104 before serving access point 104 has the opportunity to activate the new AS key (e.g., where wireless device 102 is operating in DRX mode or otherwise). In this regard, if handover determining component 202 discerns to handover communications of the wireless device to target access point 108, handover preparing component 204 can provide the new AS key to the target access point. New key obtaining component 312 can receive the new AS key from serving access point 104 during handover preparation. In addition, key change indicating component 210 can specify key change in a connection reconfiguration message (e.g., by setting a key change indicator value, specifying a KSI, and/or the like), and handover component 206 can transmit the connection reconfiguration message to the wireless device 102. Security context applying component 308 can determine the key change based on the reconfiguration message, and can apply a security context to communications based on the new AS key in communicating with target access point 108 via access point communicating component 310.

In another example, however, handover can fail (e.g., due to radio link failure, handover failure, and/or the like) in the case where new key receiving component 208 obtains a new AS key for wireless device 102 and handover is triggered before serving access point 104 has an opportunity to activate the new AS key. To handle this case, in one example, handover preparing component 204 can provide target access point 108 with a security context based on the old AS key in preparing the target access point 108 for handover. Old security context component 314 can receive the security context. Once the radio link fails, handover fails, and/or another failure occurs that prevents handover component 206 from completing handover to wireless device 102, wireless device 102 can begin communicating with target access point 108. In this regard, security context applying component can apply a security context based on the old AS key to a random access procedure, connection re-establishment message, connection re-establishment complete, and/or or other communication with target access point 108.

Access point communicating component 310 can provide the communication to target access point 108, and device communicating component 320 can receive the communication. Device communicating component 320 can retrieve the old security context from old security context component 314 and can utilize the old security context, as described, to interpret the communications. The device communicating component 320 interprets the communications, in one example, by verifying the security context, decrypting or deciphering communications using the security context, and/or the like, as described. In one example, the old security context can relate to a short MAC-I based on the old AS key, as described. Subsequently, security key activating component 318 can indicate activation of the new AS key to wireless device 102, which can include performing an intra-cell handover to wireless device 102, as described previously, and security context applying component 308 can then apply a new security context related to the new AS key to communications for target access point 108.

In another example, to handle the case where handover fails due to handover failure, radio link failure, etc., handover preparing component 204 can generate a new security context based on the new AS key and provide the context to target access point 108. In this regard, upon failure, security context applying component 308 can begin applying a new security context based on the new AS key to data to be transmitted to target access point 108. Access point communicating component 310 can accordingly perform a random access procedure, transmit a connection re-establishment message, connection re-establishment complete and/or or other communications with target access point 108 using the new security context. In this example, device communicating component 320 can receive communications from wireless device 102 and can retrieve the new security context, which can relate to a short MAC-I based on the new AS key, from new security context component 316. Device communicating component 320 can apply the new security context to the communications to appropriately interpret the communications, as described above.

It is to be appreciated that serving access point 104 can provide (and target access point 108 can receive) the new and/or old security context based on a network specification, configuration, hardcoding, and/or the like. Similarly, security context applying component 308 can select the old or new security configuration for data transmitted to target access point 108 based at least in part on a network specification, configuration, hardcoding, and/or the like. In this example, old security context component 314 and new security context component 316 need not co-exist in target access point 108.

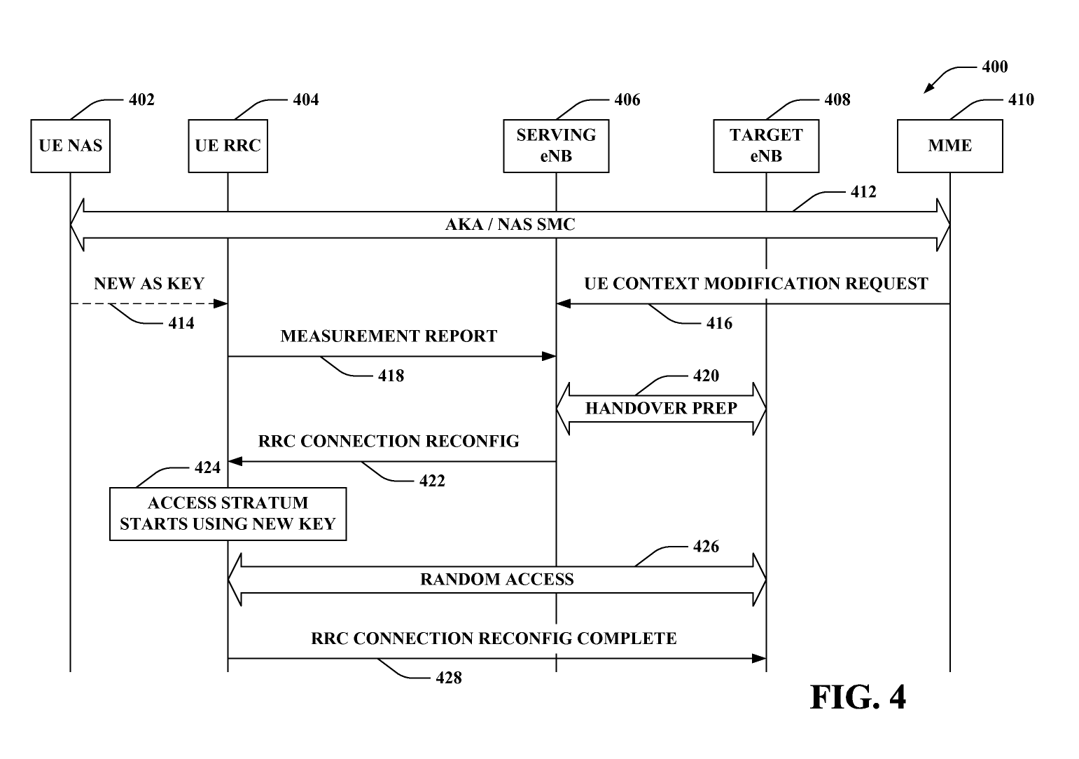

Turning to FIG. 4, an example wireless network 400 that facilitates handling security modification during handover is illustrated. Network 400 includes a UE, which is shown as UE NAS 402 representing NAS layer communications between the UE and MME 410, and UE radio resource control (RRC) 404 representing RRC layer communications between UE and serving eNB 406 and/or target eNB 408. Network 400 also includes a serving eNB 406 that provides one or more UEs with access to a wireless network, as described, a target eNB 408 that can also provide one or more UEs with wireless network access, and an MME 410 that provides authentication for UEs and/or other devices in a wireless network. In this regard, as described, serving eNB 406 and/or target eNB 408 can be macrocell, femtocell, or picocell access points, relay nodes, mobile base stations, and/or the like for example. MME 410 can be substantially any wireless network component that provides security keys to one or more network devices to facilitate verifying authentication of one or more UEs.

According to an example, UE NAS 402 can request a new security key from MME 410 by performing an AKA/NAS SMC 412 therewith. As part of the AKA/NAS SMC 412, UE NAS 402 generate a new AS key. UE NAS 402 can provide the new AS key 414 to UE RRC 404. In addition, MME 410 can provide the new AS key to serving eNB 406 in a UE context modification request 416. In this regard, once serving eNB 406 activates the new AS key with the UE RRC 404 (e.g., by intra-cell handover or a similar procedure to notify UE RRC 404 to start using the new AS key), UE RRC 404 can apply the new AS key to data transmitted to serving eNB 406. As described, applying the new AS key can include inserting the new AS key, or a security context generated from the new AS key, in data packets, encrypting or ciphering data packets based on the new AS key and/or related security context, etc. Thus, serving eNB 406 can appropriately interpret data packets from UE having the new AS key security applied.

In this example, however, serving eNB 406 does not have the opportunity to activate the new AS key with UE RRC 404 before completing a handover procedure. As described, this can happen, for example, where the related UE is operating in DRX mode such that it can transmit a measurement report 418 to serving eNB 406, triggering handover, at any time, but cannot receive communications from serving eNB 406 except during on durations of the UE receiver. As described, upon receiving the measurement report 418 from UE RRC 404, serving eNB 406 can decide to handover UE RRC 404 communications to target eNB 408 based on the measurement report. Serving eNB 406 can accordingly perform handover preparation 420 with target eNB 408, which can include providing parameters regarding communicating with UE RRC 404, such as a UE context, security parameters, authentication information, etc.

As described, since serving eNB 406 has received the new AS key, it can provide the new AS key (and/or a related security context) to target eNB 408 as part of handover preparation 420. In this regard, for example, serving eNB 406 can provide the new AS key as KeNB* to target eNB 408, and can for example provide the old AS key thereto as KeNB. Subsequently, serving eNB 406 can transmit a RRC connection reconfiguration 422 (or similar message) to UE RRC 404 to complete handover. Serving eNB 406 can specify to change security keys to the new AS key in the RRC connection reconfiguration 422 (e.g., via key change indicator set to true, providing a KSI, and/or the like). Thus, UE RRC 404 access stratum can start using the new AS key at 424. UE RRC 404 can subsequently perform random access 426 to target eNB 408 to establish a connection therewith. UE RRC 404 can additionally transmit an RRC connection reconfiguration complete 428 (or similar message) to target eNB 408 to confirm handover. It is to be appreciated that UE RRC 404 can utilize the new AS key in communicating the RRC connection reconfiguration complete message 428 to target eNB 408 (and/or in performing random access 426 thereto). Target eNB 408 can interpret the communications from UE RRC 404 according to the new AS key (KeNB*) or a related security context, as described.

In another example, serving eNB 406 can provide a key change indicator to target eNB 408 during handover preparation 420, or following successful receive of the RRC connection reconfiguration 422 at UE RRC 404, so the target eNB 408 expects to receive UE RRC 404 communications with the new AS key (KeNB*) applied. Moreover, in one example, serving eNB 406 can provision a KSI, which can be related to the new AS key, to target eNB 408 during handover preparation 420, which can make handling of the keys more transparent at target eNB 408. For example, in this regard, serving eNB 406 can provide the KSI to UE RRC 404 as well, which can apply the KSI to communications with target eNB 408, and target eNB 404 can interpret the communications based on the KSI.

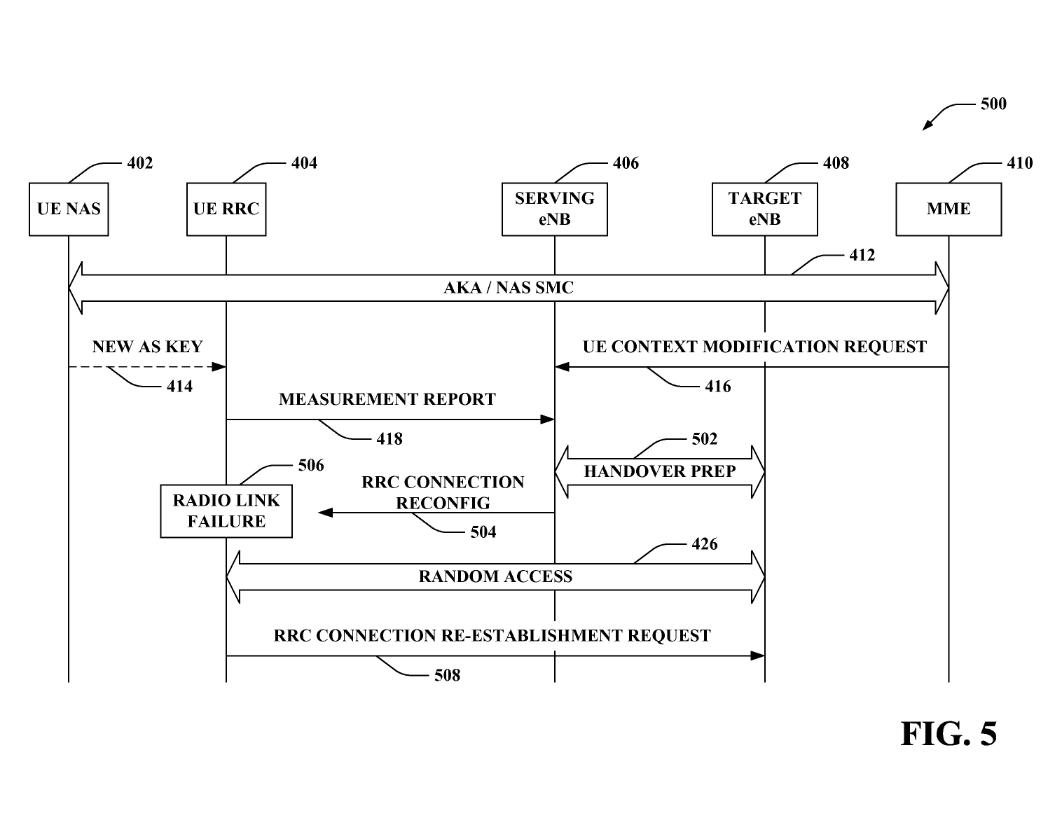

Turning to FIG. 5, an example wireless network 500 that facilitates handling security modification in the case of radio link failure during handover is illustrated. Network 500 includes a UE, which is shown as UE NAS 402 representing NAS layer communications between the UE and MME 410, and UE RRC 404 representing RRC layer communications between UE and serving eNB 406 and/or target eNB 408. Network 500 also includes a serving eNB 406 that provides one or more UEs with access to a wireless network, as described, a target eNB 408 that can also provide one or more UEs with wireless network access, and an MME 410 that provides authentication in a wireless network. In this regard, as described, serving eNB 406 and/or target eNB 408 can be macrocell, femtocell, or picocell access points, relay nodes, mobile base stations, and/or the like for example. MME 410 can be substantially any wireless network component that provides security keys to one or more network devices to facilitate verifying authentication of one or more UEs or other devices.

According to an example, UE NAS 402 can request a new security key from MME 410 by performing an AKA/NAS SMC 412 therewith. As part of the AKA/NAS SMC 412, UE NAS 402 generate a new AS key. UE NAS 402 can provide the new AS key 414 to UE RRC 404. In addition, MME 410 can provide the new AS key to serving eNB 406 in a UE context modification request 416. In this regard, once serving eNB 406 activates the new AS key with the UE RRC 404 (e.g., by intra-cell handover or a similar procedure to notify UE RRC 404 to start using the new AS key), UE RRC 404 can apply the new AS key to data transmitted to serving eNB 406. As described, applying the new AS key can include inserting the new AS key, or a security context generated from the new AS key, in data packets, encrypting or ciphering data packets based on the new AS key and/or related security context, etc. Thus, serving eNB 406 can appropriately interpret data packets from UE having the new AS key security applied.

In this example, however, serving eNB 406 does not have the opportunity to activate the new AS key with UE RRC 404 before completing a handover procedure. As described, this can happen, for example, where the related UE is operating in DRX mode such that it can transmit a measurement report 418 to serving eNB 406, triggering handover, at any time, but cannot receive communications from serving eNB 406 except during on durations of the UE receiver. As described, upon receiving the measurement report 418 from UE RRC 404, serving eNB 406 can decide to handover UE RRC 404 communications to target eNB 408 based on the measurement report. Serving eNB 406 can accordingly perform handover preparation 502 with target eNB 408, which can include providing parameters regarding communicating with UE RRC 404, such as a UE context, security parameters, authentication information, etc.

In an example, transmitting a subsequent RRC connection reconfiguration 504 (or similar message) to serving eNB 406 can fail due to radio link failure 506 between UE RRC 404 and serving eNB 406. In this example, serving eNB 406 can prepare target eNB 408 to handle such failure. In one example, serving eNB 406 can provision a security context based on the old AS key to target eNB 408 during handover preparation 502, along with the new AS key. The security context can include, for example a short MAC-I based on the old AS key. Thus, following radio link failure 506, UE RRC 404 can perform random access 426 to target eNB 408 and transmit an RRC connection re-establishment request message 508 thereto. In this example, UE RRC 404 can continue to apply the security context based on the old AS key to the communications with target eNB 408 (e.g., the RRC connection re-establishment request message 508, random access 426, and/or the like), as it did with serving eNB 406. Target eNB 408 can interpret the communications based on the security context received from serving eNB 406 in handover preparation 502. In addition, serving eNB 406, as described, can provide the new AS key to target eNB 408 during handover preparation 502. Thus, target eNB 408 can subsequently activate the new AS key with UE RRC 404.

In another example, as described, serving eNB 406 can generate a security context based on the new AS key and provide the security context to target eNB 408 in handover preparation 502. Similarly, this security context can be a short MAC-I based on the new AS key, in one example. In this regard, upon radio link failure 506, UE RRC 404 can begin using the new AS key by applying a security context based on the new AS key to communications with target eNB 408. UE RRC 404 can perform random access 426 to target eNB 408 and transmit an RRC connection re-establishment request message 508 thereto, as described. In this example, however, UE RRC 404 applies the security context based on the new AS key to the communications. In this regard, target eNB 408 can interpret the communications based at least in part on the security context received in handover preparation 502.

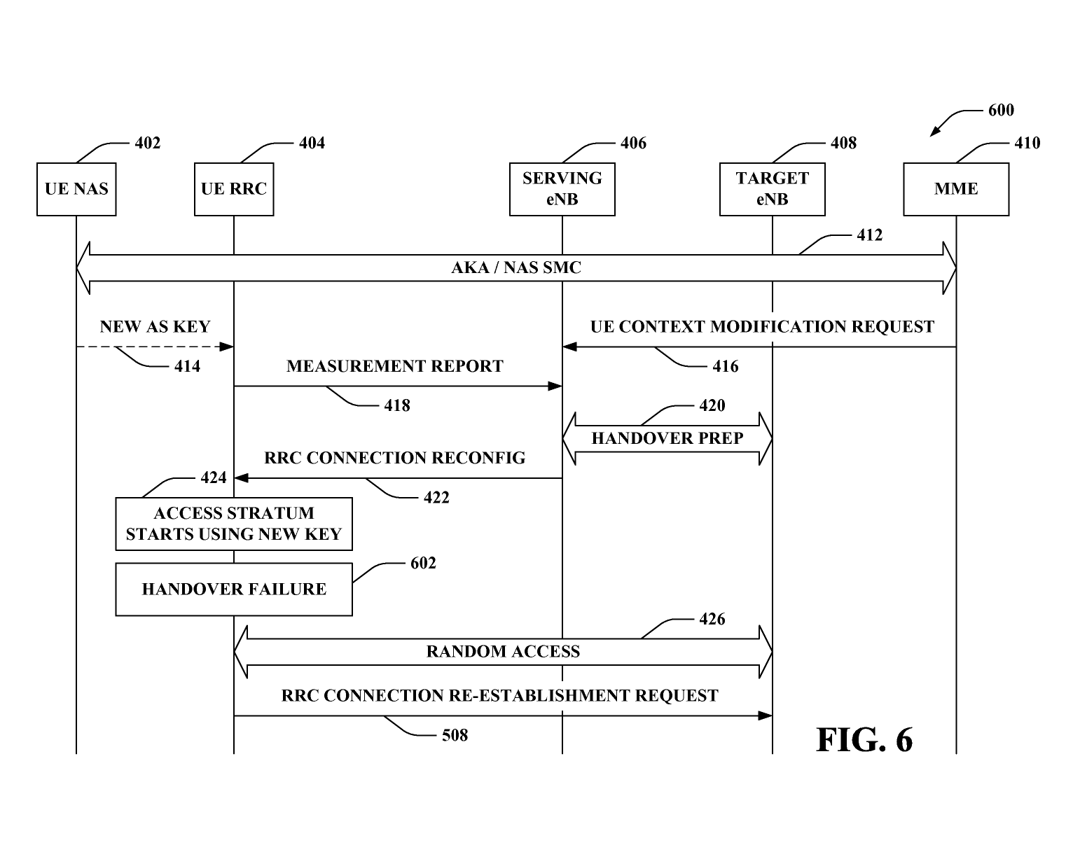

Turning to FIG. 6, an example wireless network 600 that facilitates handling security modification in the case of handover failure is illustrated. Network 600 includes a UE, which is shown as UE NAS 402 representing NAS layer communications between the UE and MME 410, and UE RRC 404 representing RRC layer communications between UE and serving eNB 406 and/or target eNB 408. Network 600 also includes a serving eNB 406 that provides one or more UEs with access to a wireless network, as described, a target eNB 408 that can also provide one or more UEs with wireless network access, and an MME 410 that provides authentication in a wireless network. In this regard, as described, serving eNB 406 and/or target eNB 408 can be macrocell, femtocell, or picocell access points, relay nodes, mobile base stations, and/or the like for example. MME 410 can be substantially any wireless network component that provides security keys to one or more network devices to facilitate verifying authentication of one or more UEs or other devices.

According to an example, UE NAS 402 can request a new security key from MME 410 by performing an AKA/NAS SMC 412 therewith. As part of the AKA/NAS SMC 412, UE NAS 402 generate a new AS key. UE NAS 402 can provide the new AS key 414 to UE RRC 404. In addition, MME 410 can provide the new AS key to serving eNB 406 in a UE context modification request 416. In this regard, once serving eNB 406 activates the new AS key with the UE RRC 404 (e.g., by intra-cell handover or a similar procedure to notify UE RRC 404 to start using the new AS key), UE RRC 404 can apply the new AS key to data transmitted to serving eNB 406. As described, applying the new AS key can include inserting the new AS key, or a security context generated from the new AS key, in data packets, encrypting or ciphering data packets based on the new AS key and/or related security context, etc. Thus, serving eNB 406 can appropriately interpret data packets from UE having the new AS key security applied.

In this example, however, serving eNB 406 does not have the opportunity to activate the new AS key with UE RRC 404 before completing a handover procedure. As described, this can happen, for example, where the related UE is operating in DRX mode such that it can transmit a measurement report 418 to serving eNB 406, triggering handover, at any time, but cannot receive communications from serving eNB 406 except during on durations of the UE receiver. As described, upon receiving the measurement report 418 from UE RRC 404, serving eNB 406 can decide to handover UE RRC 404 communications to target eNB 408 based on the measurement report. Serving eNB 406 can accordingly perform handover preparation 502 with target eNB 408, which can include providing parameters regarding communicating with UE RRC 404, such as a UE context, security parameters, authentication information, etc.

As described, since serving eNB 406 has received the new AS key, it can provide the new AS key (and/or a related security context) to target eNB 408 as part of handover preparation 420. In this regard, for example, serving eNB 406 can provide the new AS key to target eNB 408 (along with the old AS key, in one example). Subsequently, serving eNB 406 can transmit a RRC connection reconfiguration 422 (or similar message) to UE RRC 404 to complete handover. Serving eNB 406 can specify to change security keys to the new AS key in the RRC connection reconfiguration 422 (e.g., via key change indicator set to true, providing a KSI, and/or the like). Thus, UE RRC 404 access stratum can start using the new AS key at 424. Handover failure 602, however, can occur at UE RRC 404. To prepare for this occurrence, serving eNB 406 can provide a security context related to an old or new AS key to target eNB 408 during handover preparation 420, as described previously.

In one example, serving eNB 406 can provision a security context based on the old AS key to target eNB 408 during handover preparation 502 (e.g., along with the new and/or old AS keys). The security context can include, for example a short MAC-I based on the old AS key. Thus, following handover failure 602, UE RRC 404 can revert to the old security key. Subsequently, UE RRC 404 can perform random access 426 to target eNB 408 and transmit an RRC connection re-establishment request message 508 thereto. In this example, UE RRC 404 can apply the security context based on the old AS key to the communications with target eNB 408 (e.g., the RRC connection re-establishment request message 508, random access 426, and/or the like), as it did with serving eNB 406. Target eNB 408 can interpret the communications based on the security context received from serving eNB 406 in handover preparation 502. In addition, serving eNB 406, as described, can provide the new AS key to target eNB 408 during handover preparation 502. Thus, target eNB 408 can subsequently activate the new AS key with UE RRC 404.

In another example, as described, serving eNB 406 can generate a security context based on the new AS key and provide the security context to target eNB 408 in handover preparation 502. Similarly, this security context can be a short MAC-I based on the new AS key, in one example. In this regard, upon handover failure 602, UE RRC 404 can use the new AS key anyway by applying a security context based on the new AS key to communications with target eNB 408. UE RRC 404 can perform random access 426 to target eNB 408 and transmit an RRC connection re-establishment request message 508 thereto, as described. In this example, UE RRC 404 applies the security context based on the new AS key to the communications as planned. In this regard, target eNB 408 can interpret the communications based at least in part on the security context received in handover preparation 502 related to the new AS key.

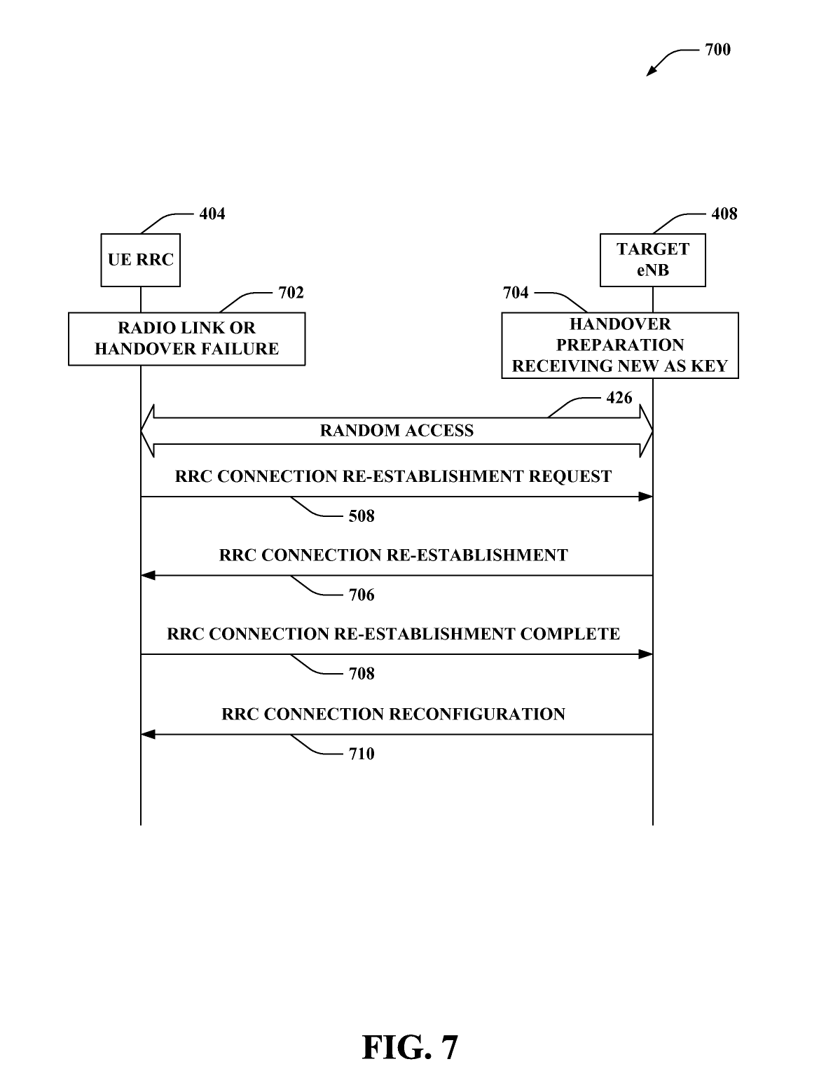

Referring to FIG. 7, an example wireless network 700 that facilitates activating new AS keys in the case of radio link or handover failure is illustrated. Network 700 includes a UE RRC 404 layer of a UE and a target eNB 408 to which UE RRC 404 handed over communications following radio link or handover failure of a serving eNB, as described. In this regard, networks 500 and 600 can utilize the depicted communications to activate a new AS key with UE RRC 404 following the radio link or handover failure where a security context based on the old AS key is utilized to interpret (e.g., verify, decipher, decrypt, etc.) the RRC connection re-establishment request message 508, RRC connection re-establishment complete 708, or similar messages from UE RRC 404.

According to an example, as described, UE RRC 404 can experience radio link or handover failure 702 during a handover procedure. In addition, target eNB 408 can perform handover preparation receiving the new AS key 704, as described, with a serving eNB (not shown). Upon the radio link or handover failure 702, UE RRC 404 can perform a random access 426 to target eNB 408 to receive resources for communicating therewith. Subsequently, UE RRC 404 can transmit an RRC connection re-establishment request message 508 to target eNB 408 to re-establish connection following the failure. In one example, UE RRC 404 can apply a security context related to the old AS key to the RRC connection re-establishment request message 508, and target eNB 408 can utilize a security context based on the old AS key to interpret the RRC connection re-establishment request message 508. For example, target eNB 408 can additionally receive the security context from the serving eNB during handover preparation, generate the security context based on the old AS key received during handover preparation, and/or the like.

Target eNB 408 can transmit an RRC connection re-establishment 706 to UE RRC 404 to continue the connection therewith. UE RRC 404 can confirm re-establishment by transmitting an RRC connection re-establishment complete 708 to the target eNB 408. In addition, for example, UE RRC 404 can apply the security context based on the old AS key to the RRC connection re-establishment complete 708, and target eNB 408 can interpret according to the security context. Target eNB 408 can then transmit an RRC connection reconfiguration 710 to UE RRC 404, which can include a key change indicator or KSI, for example, to activate the new AS key received during handover preparation. UE RRC 404 can begin applying the new AS key to subsequent communications with target eNB 408.

In another example, UE RRC 404 does not apply a security context to RRC connection re-establishment request message 508. In this example, or one or more examples above, target eNB 408 can indicate key change, as described, in RRC connection re-establishment 706. In this example, target eNB 408 need not be provisioned with the security configuration based on the old AS key; rather, UE RRC 404 can apply a security context based on the new AS key to RRC connection re-establishment complete 708. Target eNB 408 can generate the security context based on the new AS key and interpret the RRC connection re-establishment complete 708 based on the security context. Thus, target eNB 408 need not be provisioned with security contexts based on old AS keys. It is to be appreciated that target eNB 408 can alternatively send a KSI in the RRC connection re-establishment 706, which UE RRC 404 can apply to the RRC connection re-establishment complete 708 so that key management is more transparent to target eNB 408.

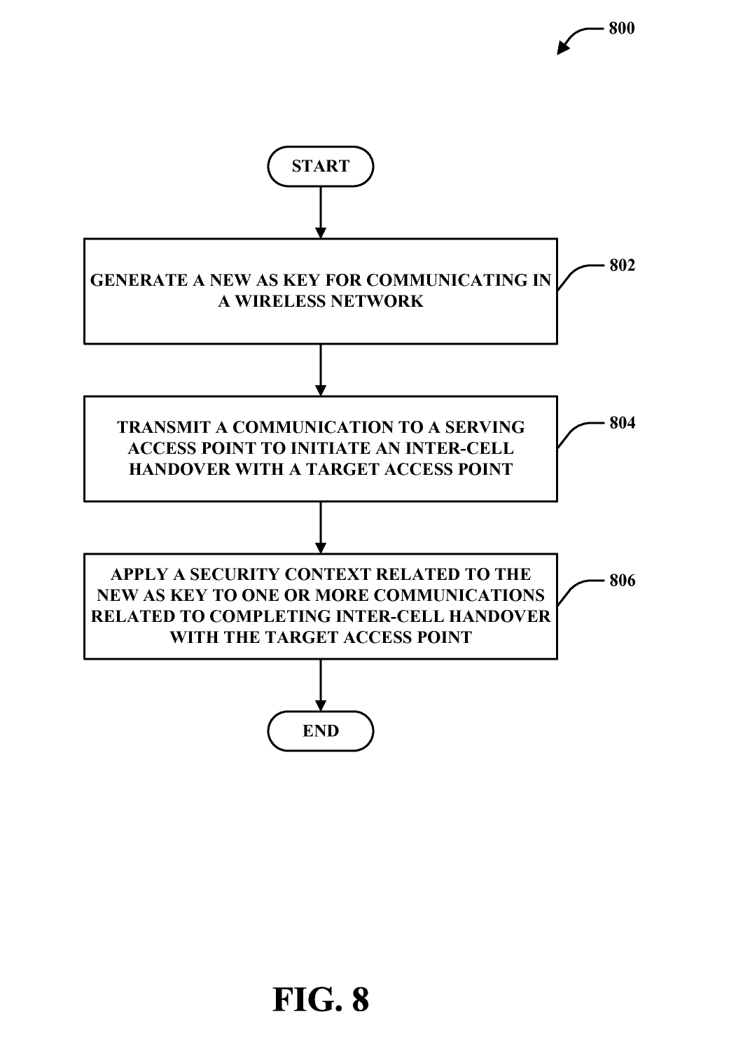

Referring now to FIGS. 8-12, methodologies that can be performed in accordance with various aspects set forth herein are illustrated. While, for purposes of simplicity of explanation, the methodologies are shown and described as a series of acts, it is to be understood and appreciated that the methodologies are not limited by the order of acts, as some acts can, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

With reference to FIG. 8, illustrated is an example methodology 800 for utilizing a new security key in communicating with a target access point following handover. At 802, a new AS key can be generated for communicating in a wireless network. The AS key, for example, can be generated or otherwise obtained as part of an AKA/NAS SMC or similar security control procedure. At 804, a communication can be transmitted to a serving access point to initiate an inter-cell handover with a target access point. As described, the communication can be transmitted according to a security context based on an old AS key. Furthermore, as described, the communication can be or relate to a measurement report generated based on communications metrics from one or more neighboring access points. At 806, a security context related to the new AS key can be applied to one or more communications related to completing inter-cell handover with the target access point.

As described, for example, the one or more communications can relate to a random access procedure or connection reconfiguration complete message (e.g., in response to a connection reconfiguration message received from the serving access point, which can have indicated a key change to the new AS key). In another example, the one or more communications can relate to transmissions resulting from a detected radio link or handover failure, such as a connection re-establishment request, connection re-establishment complete, and/or similar messages for the target access point. Thus, the new AS key can be activated as part of an inter-cell handover.

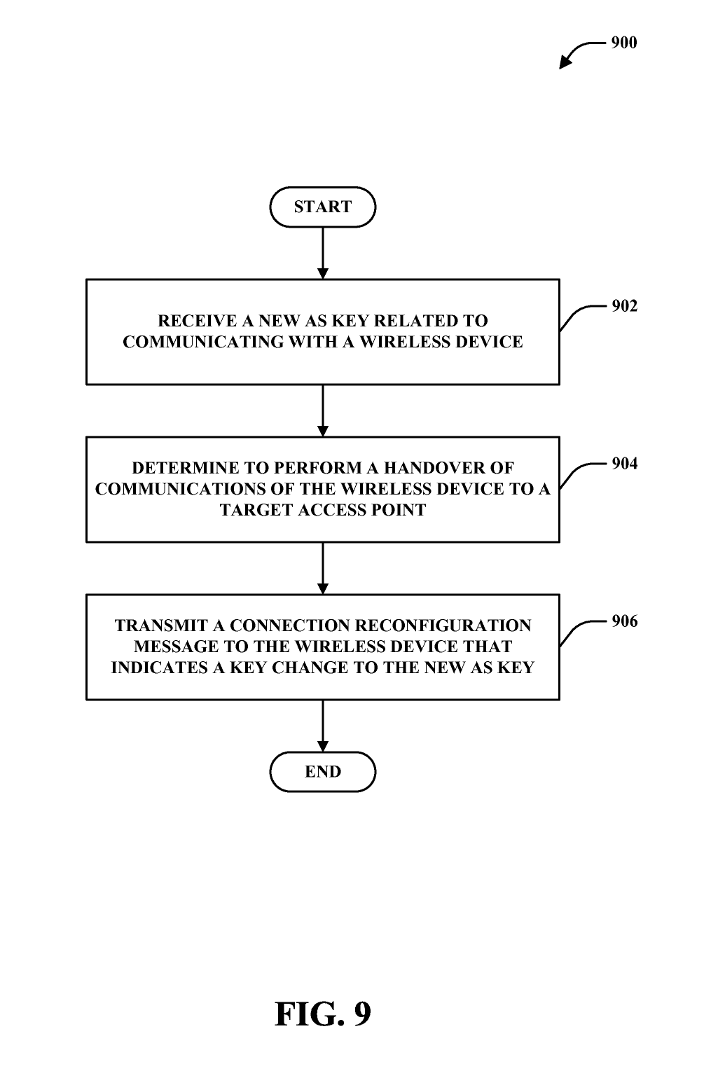

Turning to FIG. 9, an example methodology 900 is illustrated that facilitates indicating key change as part of an inter-cell handover. At 902, a new AS key can be received related to communicating with a wireless device. As described, the new AS key can be received from an MME or similar network component. At 904, it can be determined to perform a handover of communications of the wireless device to a target access point. This can occur before security key activation with the wireless device, for example (e.g., where the wireless device is operating in DRX mode, as described). Furthermore, determining to perform the handover can be based at least in part on a measurement report received from the wireless device. At 906, a connection reconfiguration message can be transmitted to the wireless device that indicates a key change to the new AS key. In this regard, handover can be completed based on transmitting the connection reconfiguration message, and the wireless device can communicate with the target access point using the new AS key based on the indicated key change, which can include a true key change indicator value or KSI, as described.

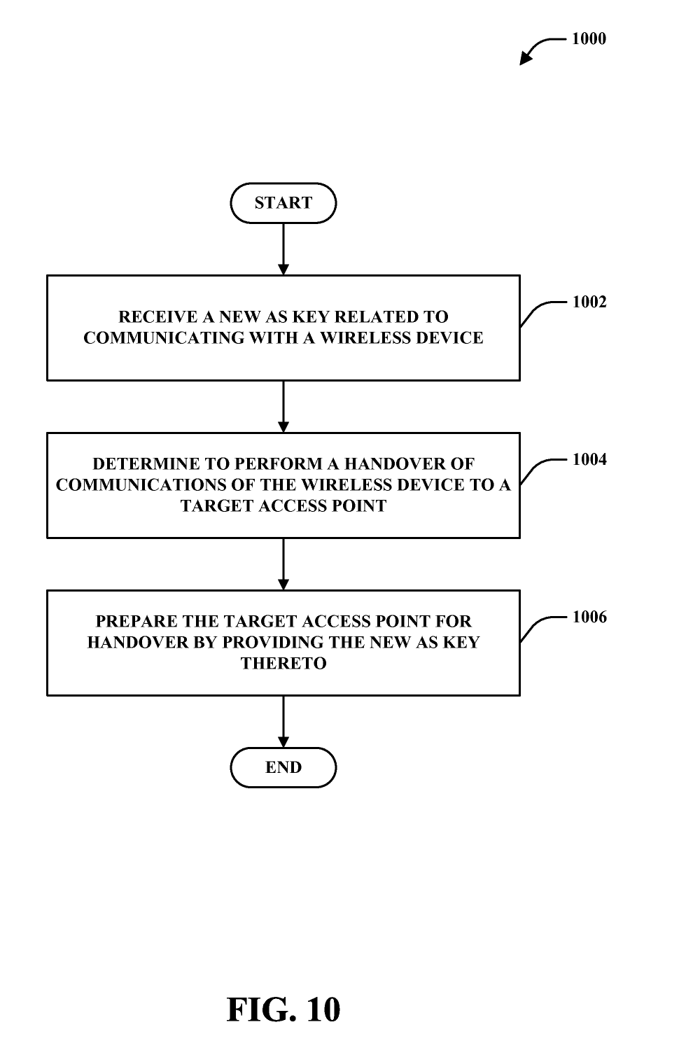

Turning to FIG. 10, an example methodology 1000 is illustrated that facilitates preparing a target eNB for handover of communications of a wireless device after receiving a new AS key for the wireless device. At 1002, a new AS key can be received related to communicating with a wireless device. As described, the new AS key can be received from an MME or similar network component. At 904, it can be determined to perform a handover of communications of the wireless device to a target access point. This can occur before security key activation with the wireless device, for example (e.g., where the wireless device is operating in DRX mode, as described). Furthermore, determining to perform the handover can be based at least in part on a measurement report received from the wireless device. At 906, the target access point can be prepared for handover by providing the new AS key thereto. Thus, for example, the target access point can apply the new AS key to communications received from the wireless device. It is to be appreciated that other security parameters can be provided to the target access point as part of handover preparation, such as an old AS key, security context based on one or more of the AS keys, and/or the like, which can be utilized to communicate with the wireless device in certain cases, as described previously.

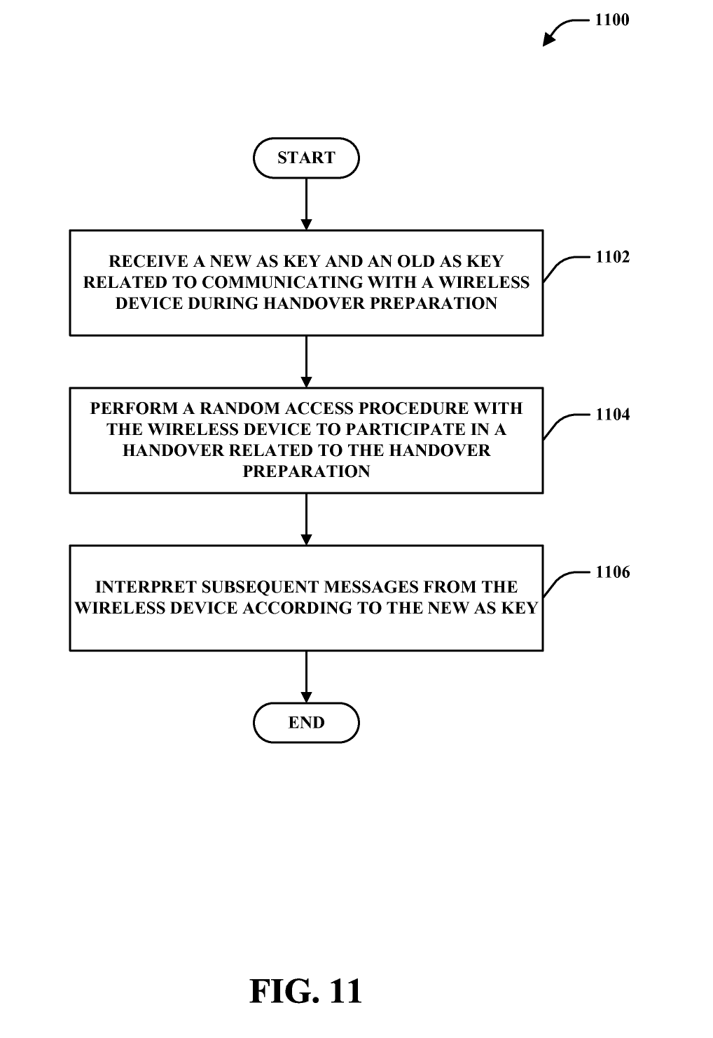

With reference to FIG. 11, illustrated is an example methodology 1100 for interpreting communications from a wireless device following a handover using a new AS key received during handover preparation. At 1102, a new AS key and an old AS key related to communicating with a wireless device can be received during handover preparation. At 1104, a random access procedure can be performed with the wireless device to participate in a handover related to the handover preparation. The handover can be from a serving access point, as described. At 1106, subsequent messages from the wireless device can be interpreted according to the new AS key. Thus, new key activation can occur during handover, as described. Moreover, as described, interpreting the messages can include verifying a security context based on the new AS key, deciphering or decrypting the communications according to the new AS key, and/or the like.

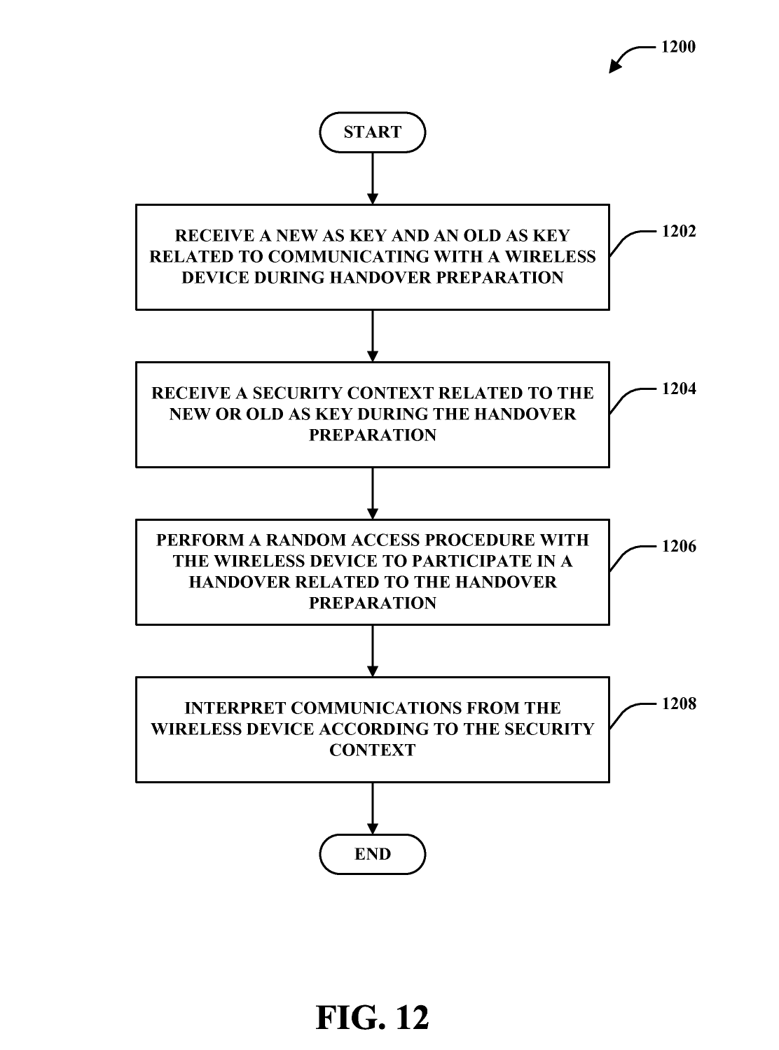

Turning to FIG. 12, illustrated is an example methodology 1200 for interpreting communications from a wireless device following a handover using a security context based on a new or old AS key received during handover preparation. At 1202, a new AS key and an old AS key related to communicating with a wireless device can be received during handover preparation. At 1204, a security context related to the new or old AS key can be received during the handover preparation. For example, as described, the security context can be a short MAC-I. At 1206, a random access procedure can be performed with the wireless device to participate in a handover related to the handover preparation. The handover can be from a serving access point, as described. At 1208, communications from the wireless device can be interpreted according to the security context. Thus, for example, where handover fails at the wireless device, due to radio link or other failure, the wireless device can transmit communications according to a security context based on the old AS key. The communications can be interpreted according to the security context based on the old AS key. Similarly, as described, a security context based on the new AS key can be utilized following handover failure or radio link failure.

It will be appreciated that, in accordance with one or more aspects described herein, inferences can be made regarding determining an AS key to use in communicating with a wireless device, preparing a target access point for handover, detecting radio link or handover failure, and/or the like. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

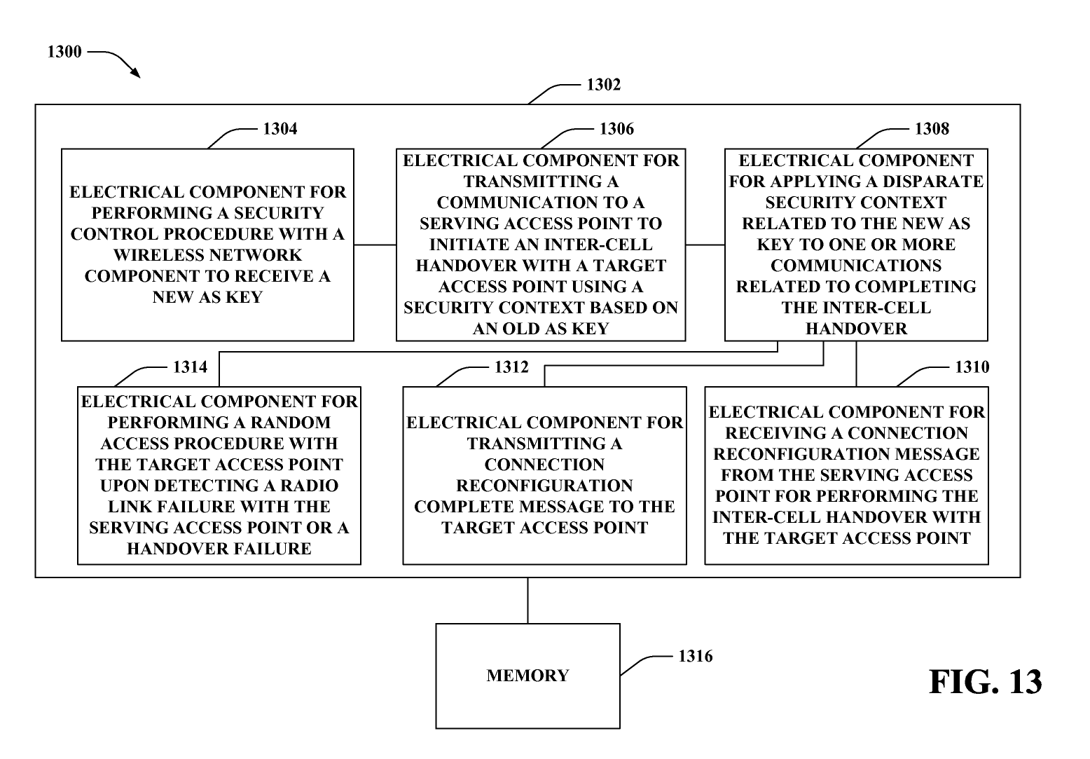

With reference to FIG. 13, illustrated is a system 1300 that communicates with a target access point following handover using a new AS key received before handover. For example, system 1300 can reside at least partially within a base station, mobile device, etc. It is to be appreciated that system 1300 is represented as including functional blocks, which can be functional blocks that represent functions implemented by a processor, software, or combination thereof (e.g., firmware). System 1300 includes a logical grouping 1302 of electrical components that can act in conjunction. For instance, logical grouping 1302 can include an electrical component for performing a security control procedure (e.g., SMC and/or the like) with a wireless network component to receive an AS key 1304. In one example, as described, the wireless network component can be an MME or similar component. Further, logical grouping 1302 can comprise an electrical component for transmitting a communication to a serving access point to initiate an inter-cell handover with a target access point using a security context based on an old AS key 1306. As described, the communication can, in one example, be a measurement report that includes communications metrics related to the target access point, which can be improved or more desirable over those of a serving access point. In any case, communications can still be based on an old AS key as serving access point has not yet had the opportunity to activate the new AS key, as described.

Moreover, logical grouping 1302 includes an electrical component for applying a disparate security context related to the new AS key to one or more communications related to completing the inter-cell handover 1308. Thus, for example, the new AS key can be activated during handover. In this regard, logical grouping 1302 can also include an electrical component for receiving a connection reconfiguration message from the serving access point for performing the inter-cell handover with the target access point 1310. The connection reconfiguration message, as described, can indicate key change (e.g., via key change indicator, KSI, and/or the like), and the new AS key is utilized by electrical component 1308, as described. In addition, logical grouping 1302 can include an electrical component for transmitting a connection reconfiguration complete message to the target access point 1312. As described, this can be one of the one or more communications over which the new AS key is applied.

Further, logical grouping 1302 can include an electrical component for performing a random access procedure with the target access point upon detecting a radio link failure with the serving access point or a handover failure 1314. In this regard, as described, system 1300 can continue communications with the target access point though a link to the serving access point or handover failed. Therefore, as described, electrical component 1314 can subsequently transmit a connection re-establishment request, connection re-establishment complete, and/or other messages using a security context based on the old AS key or on the new AS key, as described, depending on a network specification, configuration, hardcoding, etc. Additionally, system 1300 can include a memory 1316 that retains instructions for executing functions associated with electrical components 1304, 1306, 1308, 1310, 1312, and 1314. While shown as being external to memory 1316, it is to be understood that one or more of electrical components 1304, 1306, 1308, 1310, 1312, and 1314 can exist within memory 1316.

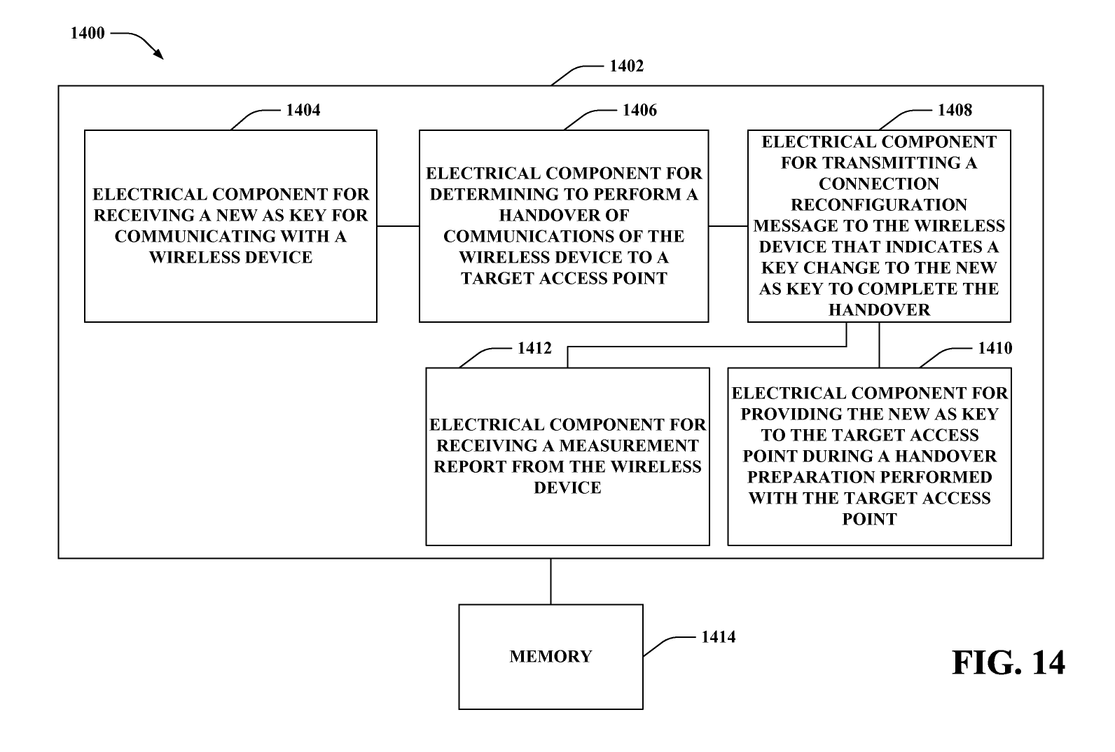

With reference to FIG. 14, illustrated is a system 1400 that prepares a target access point for handover by providing a new AS key, old AS key, and/or related security contexts. For example, system 1400 can reside at least partially within a base station, mobile device, etc. It is to be appreciated that system 1400 is represented as including functional blocks, which can be functional blocks that represent functions implemented by a processor, software, or combination thereof (e.g., firmware). System 1400 includes a logical grouping 1402 of electrical components that can act in conjunction. For instance, logical grouping 1402 can include an electrical component for receiving a new AS key for communicating with a wireless device 1404. In one example, the AS key can be received in a UE context modification request or similar message. Further, logical grouping 1402 can comprise an electrical component for determining to handover communications of the wireless device to a target access point 1406. As described, this can be based on a received measurement report (e.g., based at least in part on parameters comprised in the measurement report and/or comparing the parameters to similar parameters of system 1400 with respect to the wireless device).

Moreover, logical grouping 1402 includes an electrical component for transmitting a connection reconfiguration message to the wireless device that indicates a key change to the new AS key to complete handover 1408. Thus, for example, the new AS key can be activated by the wireless device as part of the inter-cell handover to the target access point. Logical grouping 1402 can also include an electrical component for providing the new AS key to the target access point during a handover preparation performed with the target access point 1410. Thus, the target access point can appropriately interpret communications from the wireless device using the new AS key following handover.

It is to be appreciated, as described, that electrical component 1410 can additionally or alternatively transmit security contexts related to the old and/or new AS keys to the target access point to handle radio link and handover failure cases, as described. In addition, logical grouping 1402 can include an electrical component for receiving a measurement report from the wireless device 1412, which can be used to determine to perform handover, as described above. Additionally, system 1400 can include a memory 1414 that retains instructions for executing functions associated with electrical components 1404, 1406, 1408, 1410, and 1412. While shown as being external to memory 1414, it is to be understood that one or more of electrical components 1404, 1406, 1408, 1410, and 1412 can exist within memory 1414.

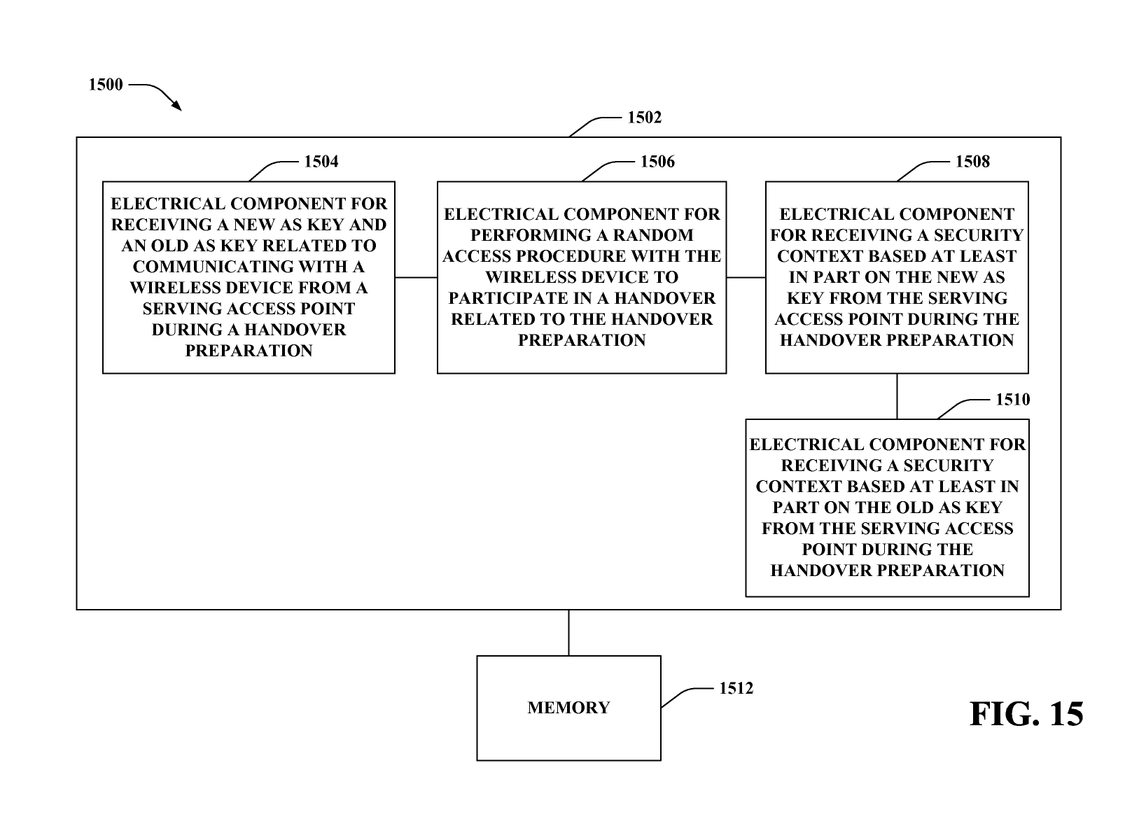

With reference to FIG. 15, illustrated is a system 1500 that interprets communications from a wireless device following handover using a new AS key, an old AS key, or a related security context. For example, system 1500 can reside at least partially within a base station, mobile device, etc. It is to be appreciated that system 1500 is represented as including functional blocks, which can be functional blocks that represent functions implemented by a processor, software, or combination thereof (e.g., firmware). System 1500 includes a logical grouping 1502 of electrical components that can act in conjunction. For instance, logical grouping 1502 can include an electrical component for receiving a new AS key and an old AS key related to communicating with a wireless device from a serving access point during a handover preparation 1504. As described, the new AS key and/or old AS key can be utilized for interpreting communications from the wireless device (e.g., by verifying, deciphering, decrypting, etc. communications using an AS key or related security context). Further, logical grouping 1502 can comprise an electrical component for performing a random access procedure with the wireless device to participate in a handover related to the handover preparation 1506. For example, subsequent messages from the wireless device can be interpreted using the new AS key or a related security context, as described.

Moreover, logical grouping 1502 includes an electrical component for receiving a security context based at least in part on the new AS key from the serving access point during the handover preparation 1508. Logical grouping 1502 can also include an electrical component for receiving a security context based at least in part on the old AS key from the serving access point during the handover preparation 1510. It is to be appreciated, for example, that electrical components 1508 and 1510 can exist or be utilized in the alternative. For example, as described, the security context from either electrical component can be utilized to interpret wireless device communications in the case of radio link or handover failure, depending on a network specification, configuration, hardcoding, etc. Additionally, system 1500 can include a memory 1512 that retains instructions for executing functions associated with electrical components 1504, 1506, 1508, and 1510. While shown as being external to memory 1512, it is to be understood that one or more of electrical components 1504, 1506, 1508, and 1510 can exist within memory 1512.

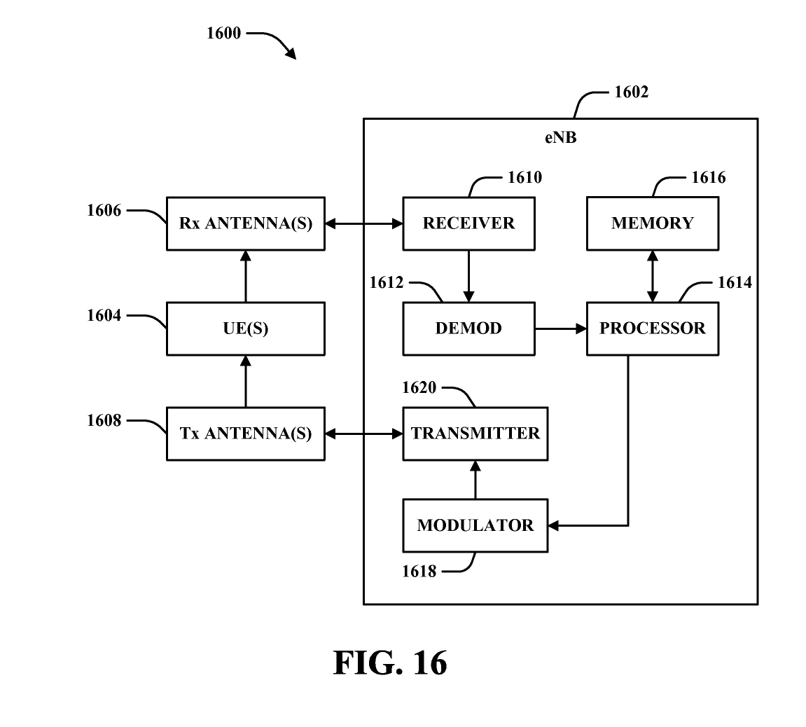

FIG. 16 is a block diagram of a system 1600 that can be utilized to implement various aspects of the functionality described herein. In one example, system 1600 includes a base station or eNB 1602. As illustrated, eNB 1602 can receive signal(s) from one or more UEs 1604 via one or more receive (Rx) antennas 1606 and transmit to the one or more UEs 1604 via one or more transmit (Tx) antennas 1608. Additionally, eNB 1602 can comprise a receiver 1610 that receives information from receive antenna(s) 1606. In one example, the receiver 1610 can be operatively associated with a demodulator (Demod) 1612 that demodulates received information. Demodulated symbols can then be analyzed by a processor 1614. Processor 1614 can be coupled to memory 1616, which can store information related to code clusters, access terminal assignments, lookup tables related thereto, unique scrambling sequences, and/or other suitable types of information. In one example, eNB 1602 can employ processor 1614 to perform methodologies 800, 900, 1000, 1100, 1200, and/or other similar and appropriate methodologies. eNB 1602 can also include a modulator 1618 that can multiplex a signal for transmission by a transmitter 1620 through transmit antenna(s) 1608.

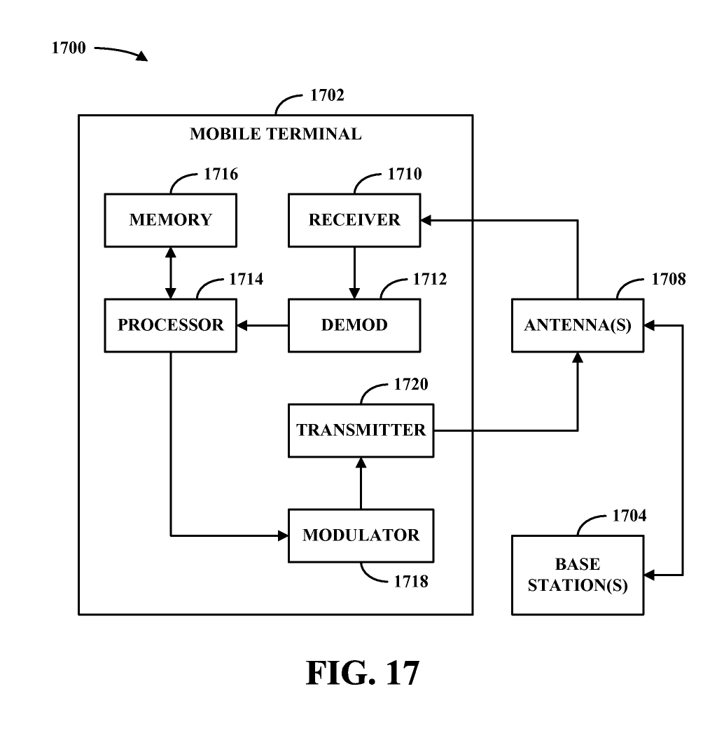

FIG. 17 is a block diagram of another system 1700 that can be utilized to implement various aspects of the functionality described herein. In one example, system 1700 includes a mobile terminal 1702. As illustrated, mobile terminal 1702 can receive signal(s) from one or more base stations 1704 and transmit to the one or more base stations 1704 via one or more antennas 1708. Additionally, mobile terminal 1702 can comprise a receiver 1710 that receives information from antenna(s) 1708. In one example, receiver 1710 can be operatively associated with a demodulator (Demod) 1712 that demodulates received information. Demodulated symbols can then be analyzed by a processor 1714. Processor 1714 can be coupled to memory 1716, which can store data and/or program codes related to mobile terminal 1702. Additionally, mobile terminal 1702 can employ processor 1714 to perform methodologies 800, 900, 1000, 1100, 1200, and/or other similar and appropriate methodologies. Mobile terminal 1702 can also employ one or more components described in previous figures to effectuate the described functionality; in one example, the components can be implemented by the processor 1714. Mobile terminal 1702 can also include a modulator 1718 that can multiplex a signal for transmission by a transmitter 1720 through antenna(s) 1708.

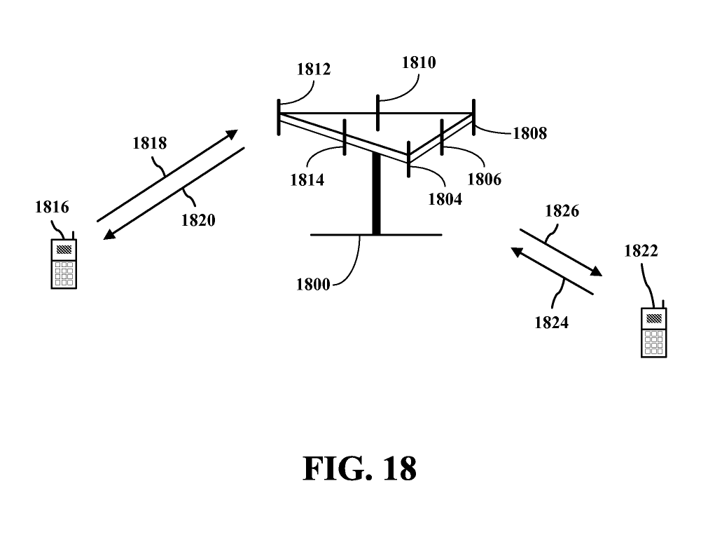

Referring now to FIG. 18, an illustration of a wireless multiple-access communication system is provided in accordance with various aspects. In one example, an access point 1800 (AP) includes multiple antenna groups. As illustrated in FIG. 18, one antenna group can include antennas 1804 and 1806, another can include antennas 1808 and 1810, and another can include antennas 1812 and 1814. While only two antennas are shown in FIG. 18 for each antenna group, it should be appreciated that more or fewer antennas may be utilized for each antenna group. In another example, an access terminal 1816 can be in communication with antennas 1812 and 1814, where antennas 1812 and 1814 transmit information to access terminal 1816 over forward link 1820 and receive information from access terminal 1816 over reverse link 1818. Additionally and/or alternatively, access terminal 1822 can be in communication with antennas 1806 and 1808, where antennas 1806 and 1808 transmit information to access terminal 1822 over forward link 1826 and receive information from access terminal 1822 over reverse link 1824. In a frequency division duplex system, communication links 1818, 1820, 1824 and 1826 can use different frequency for communication. For example, forward link 1820 may use a different frequency then that used by reverse link 1818.

Each group of antennas and/or the area in which they are designed to communicate can be referred to as a sector of the access point. In accordance with one aspect, antenna groups can be designed to communicate to access terminals in a sector of areas covered by access point 1800. In communication over forward links 1820 and 1826, the transmitting antennas of access point 1800 can utilize beamforming in order to improve the signal-to-noise ratio of forward links for the different access terminals 1816 and 1822. Also, an access point using beamforming to transmit to access terminals scattered randomly through its coverage causes less interference to access terminals in neighboring cells than an access point transmitting through a single antenna to all its access terminals.

An access point, e.g., access point 1800, can be a fixed station used for communicating with terminals and can also be referred to as a base station, an eNB, an access network, and/or other suitable terminology. In addition, an access terminal, e.g., an access terminal 1816 or 1822, can also be referred to as a mobile terminal, user equipment, a wireless communication device, a terminal, a wireless terminal, and/or other appropriate terminology.

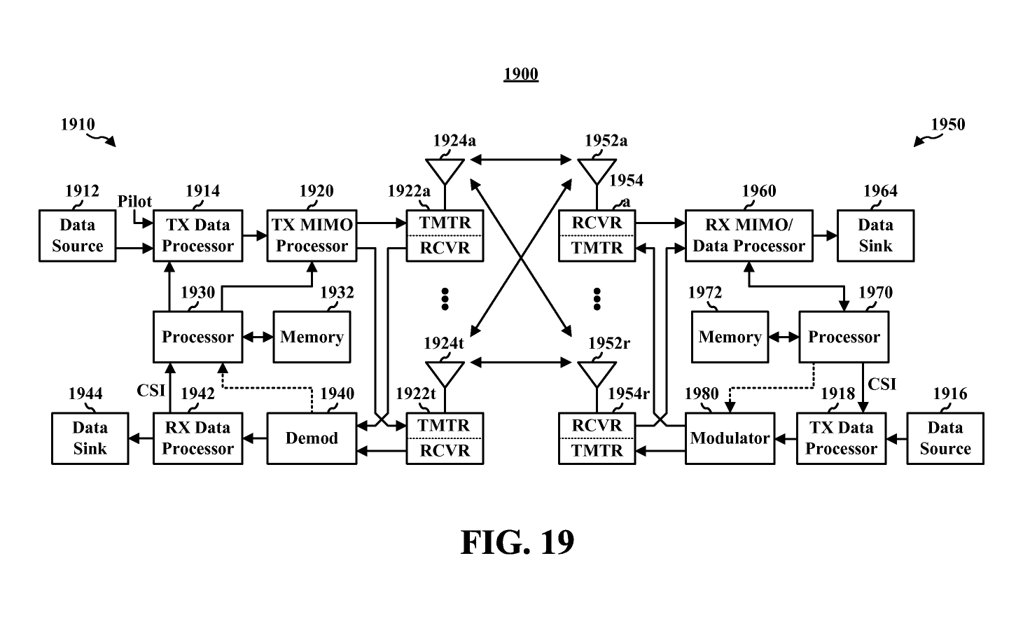

Referring now to FIG. 19, a block diagram illustrating an example wireless communication system 1900 in which various aspects described herein can function is provided. In one example, system 1900 is a multiple-input multiple-output (MIMO) system that includes a transmitter system 1910 and a receiver system 1950. It should be appreciated, however, that transmitter system 1910 and/or receiver system 1950 could also be applied to a multi-input single-output system wherein, for example, multiple transmit antennas (e.g., on a base station), can transmit one or more symbol streams to a single antenna device (e.g., a mobile station). Additionally, it should be appreciated that aspects of transmitter system 1910 and/or receiver system 1950 described herein could be utilized in connection with a single output to single input antenna system.

In accordance with one aspect, traffic data for a number of data streams are provided at transmitter system 1910 from a data source 1912 to a transmit (TX) data processor 1914. In one example, each data stream can then be transmitted via a respective transmit antenna 1924. Additionally, TX data processor 1914 can format, encode, and interleave traffic data for each data stream based on a particular coding scheme selected for each respective data stream in order to provide coded data. In one example, the coded data for each data stream can then be multiplexed with pilot data using OFDM techniques. The pilot data can be, for example, a known data pattern that is processed in a known manner. Further, the pilot data can be used at receiver system 1950 to estimate channel response. Back at transmitter system 1910, the multiplexed pilot and coded data for each data stream can be modulated (i.e., symbol mapped) based on a particular modulation scheme (e.g., BPSK, QSPK, M-PSK, or M-QAM) selected for each respective data stream in order to provide modulation symbols. In one example, data rate, coding, and modulation for each data stream can be determined by instructions performed on and/or provided by processor 1930.

Next, modulation symbols for all data streams can be provided to a TX MIMO processor 1920, which can further process the modulation symbols (e.g., for OFDM). TX MIMO processor 1920 can then provides N_{T} modulation symbol streams to N_{T} transceivers 1922a through 1922t. In one example, each transceiver 1922 can receive and process a respective symbol stream to provide one or more analog signals. Each transceiver 1922 can then further condition (e.g., amplify, filter, and upconvert) the analog signals to provide a modulated signal suitable for transmission over a MIMO channel. Accordingly, N_{T} modulated signals from transceivers 1922a through 1922t can then be transmitted from N_{T} antennas 1924a through 1924t, respectively.

In accordance with another aspect, the transmitted modulated signals can be received at receiver system 1950 by N_{R} antennas 1952a through 1952r. The received signal from each antenna 1952 can then be provided to respective transceivers 1954. In one example, each transceiver 1954 can condition (e.g., filter, amplify, and downconvert) a respective received signal, digitize the conditioned signal to provide samples, and then processes the samples to provide a corresponding “received” symbol stream. An RX MIMO/data processor 1960 can then receive and process the N_{R} received symbol streams from N_{R} transceivers 1954 based on a particular receiver processing technique to provide N_{T} “detected” symbol streams. In one example, each detected symbol stream can include symbols that are estimates of the modulation symbols transmitted for the corresponding data stream. RX MIMO/data processor 1960 can then process each symbol stream at least in part by demodulating, deinterleaving, and decoding each detected symbol stream to recover traffic data for a corresponding data stream. Thus, the processing by RX MIMO/data processor 1960 can be complementary to that performed by TX MIMO processor 1920 and TX data processor 1918 at transmitter system 1910. RX MIMO/data processor 1960 can additionally provide processed symbol streams to a data sink 1964.

In accordance with one aspect, the channel response estimate generated by RX MIMO/data processor 1960 can be used to perform space/time processing at the receiver, adjust power levels, change modulation rates or schemes, and/or other appropriate actions. Additionally, RX MIMO/data processor 1960 can further estimate channel characteristics such as, for example, signal-to-noise-and-interference ratios (SNRs) of the detected symbol streams. RX MIMO/data processor 1960 can then provide estimated channel characteristics to a processor 1970. In one example, RX MIMO/data processor 1960 and/or processor 1970 can further derive an estimate of the “operating” SNR for the system. Processor 1970 can then provide channel state information (CSI), which can comprise information regarding the communication link and/or the received data stream. This information can include, for example, the operating SNR. The CSI can then be processed by a TX data processor 1918, modulated by a modulator 1980, conditioned by transceivers 1954a through 1954r, and transmitted back to transmitter system 1910. In addition, a data source 1916 at receiver system 1950 can provide additional data to be processed by TX data processor 1918.

Back at transmitter system 1910, the modulated signals from receiver system 1950 can then be received by antennas 1924, conditioned by transceivers 1922, demodulated by a demodulator 1940, and processed by a RX data processor 1942 to recover the CSI reported by receiver system 1950. In one example, the reported CSI can then be provided to processor 1930 and used to determine data rates as well as coding and modulation schemes to be used for one or more data streams. The determined coding and modulation schemes can then be provided to transceivers 1922 for quantization and/or use in later transmissions to receiver system 1950. Additionally and/or alternatively, the reported CSI can be used by processor 1930 to generate various controls for TX data processor 1914 and TX MIMO processor 1920. In another example, CSI and/or other information processed by RX data processor 1942 can be provided to a data sink 1944.

In one example, processor 1930 at transmitter system 1910 and processor 1970 at receiver system 1950 direct operation at their respective systems. Additionally, memory 1932 at transmitter system 1910 and memory 1972 at receiver system 1950 can provide storage for program codes and data used by processors 1930 and 1970, respectively. Further, at receiver system 1950, various processing techniques can be used to process the N_{R} received signals to detect the N_{T} transmitted symbol streams. These receiver processing techniques can include spatial and space-time receiver processing techniques, which can also be referred to as equalization techniques, and/or “successive nulling/equalization and interference cancellation” receiver processing techniques, which can also be referred to as “successive interference cancellation” or “successive cancellation” receiver processing techniques.

It is to be understood that the aspects described herein can be implemented by hardware, software, firmware, middleware, microcode, or any combination thereof. When the systems and/or methods are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

What has been described above includes examples of one or more aspects. It is, of course, not possible to describe every conceivable combination of components or methodologies for purposes of describing the aforementioned aspects, but one of ordinary skill in the art can recognize that many further combinations and permutations of various aspects are possible. Accordingly, the described aspects are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is meant to be a “non-exclusive or.”

What is claimed is:

1. A method, comprising:
generating a new access stratum (AS) key during a security control procedure with a wireless network component;
transmitting a communication to the serving access point that initiates an inter-cell handover with a target access point using a security context related to the old AS key; and
applying a disparate security context related to the new AS key to one or more communications related to completing the inter-cell handover with the target access point.

2. The method of claim 1, further comprising receiving a connection reconfiguration message from the serving access point for performing the inter-cell handover with the target access point.

3. The method of claim 2, further comprising determining to apply the disparate security context related to the new AS key to the one or more communications based at least in part on a true key change indicator value or a key stream identifier in the connection reconfiguration message.

4. The method of claim 1, further comprising transmitting a connection reconfiguration complete message to the target access point, wherein the one or more communications related to completing the inter-cell handover includes the connection reconfiguration complete message.

5. The method of claim 1, further comprising:
detecting a radio link failure with the serving access point or a handover failure; and
performing a random access procedure with the target access point.

6. The method of claim 5, further comprising transmitting a connection re-establishment request to the target access point, wherein the connection re-establishment request includes a short message authentication code for integrity check related to the new AS key or the old AS key.

7. The method of claim 6, wherein the one or more communications related to completing the inter-cell handover includes the connection re-establishment request.

8. The method of claim 6, further comprising receiving a connection re-establishment message from the target access point that specifies a key change indicator or a key stream identifier.

9. The method of claim 8, further comprising:
applying the disparate security context related to the new AS key to a connection re-establishment complete message; and
transmitting the connection re-establishment complete message to the target access point.

10. The method of claim 1, further comprising applying the disparate security context related to the new AS key to one or more communications following handover with the target access point.

11. A wireless communications apparatus, comprising:
at least one processor configured to:
obtain a new access stratum (AS) key during a security control procedure;
provide a communication to a serving access point relating to inter-cell handover to a target access point using a security context based on an old AS key; and
apply a disparate security context related to the new AS key to one or more communications for the target access point related to completing an inter-cell handover to the target access point; and
a memory coupled to the at least one processor.

12. The wireless communications apparatus of claim 11, wherein the at least one processor is further configured to obtain a connection reconfiguration message from the serving access point for performing the inter-cell handover with the target access point.

13. An apparatus, comprising:
means for performing a security control procedure with a wireless network component to receive a new access stratum (AS) key;
means for transmitting a communication to a serving access point to initiate an inter-cell handover with a target access point using a security context based on an old AS key; and
means for applying a disparate security context related to the new AS key to one or more communications related to completing the inter-cell handover with the target access point.

14. The apparatus of claim 13, further comprising means for receiving a connection reconfiguration message from the serving access point for performing the inter-cell handover with the target access point.

15. The apparatus of claim 14, wherein the means for applying the disparate security context determines to apply the disparate security context related to the new AS key to the one or more communications based at least in part on a true key change indicator value or a key stream identifier in the connection reconfiguration message.

16. A computer program product, comprising:
a computer-readable medium comprising:
code for causing at least one computer to generate a new access stratum (AS) key based at least in part on a security control procedure with a wireless network component;
code for causing the at least one computer to transmit a communication to a serving access point to initiate an inter-cell handover with a target access point using a security context based on an old AS key; and
code for causing the at least one computer to apply a disparate security context related to the new AS key to one or more communications related to completing the inter-cell handover with the target access point.

17. The computer program product of claim 16, wherein the computer-readable medium further comprises code for causing the at least one computer to receive a connection reconfiguration message from the serving access point for performing the inter-cell handover with the target access point.

18. An apparatus, comprising:
an authentication and key agreement (AKA)/non-access stratum (NAS) security mode command (SMC) component that performs a security control procedure with a wireless network component to receive a new access stratum (AS) key;
a measurement report component that transmits a communication to a serving access point to initiate an inter-cell handover with a target access point using an security context based on an old AS key; and
a security context applying component that associates a disparate security context related to the new AS key to one or more communications related to completing the inter-cell handover with the target access point.

19. The apparatus of claim 18, further comprising an access point communicating component that receives a connection reconfiguration message from the serving access point for performing the inter-cell handover with the target access point.

20. A method, comprising:
receiving a new access stratum (AS) key related to communicating with a wireless device;
determining to perform a handover of communications of the wireless device to a target access point; and
transmitting a connection reconfiguration message to the wireless device that indicates a key change to the new AS key to complete the handover of communications of the wireless device to the target access point.

21. The method of claim 20, further comprising providing the new AS key to the target access point during a handover preparation performed with the target access point.

22. The method of claim 21, further comprising providing a security context based at least in part on the new AS key to the target access point during the handover preparation performed with the target access point.

23. The method of claim 22, wherein the security context is at least in part a short message authentication code for integrity check based at least in part on the new AS key.

24. The method of claim 21, further comprising providing a security context based at least in part on an old AS key to the target access point during a handover preparation performed with the target access point.

25. The method of claim 20, further comprising receiving a communication from the wireless device, wherein the determining to perform the handover of communications of the wireless device to the target access point is based at least in part on the communication.

26. A wireless communications apparatus, comprising:
at least one processor configured to:
obtain a new access stratum (AS) key related to communicating with a wireless device;
decide to perform a handover of communications of the wireless device to a target access point; and
provide a connection reconfiguration message to the wireless device to complete the handover of communications of the wireless device to the target access point, wherein the connection reconfiguration message specifies a key change to the new AS key or a disparate key stream identifier; and
a memory coupled to the at least one processor.

27. The wireless communications apparatus of claim 26, wherein the at least one processor is further configured to provision the new AS key to the target access point in a handover preparation procedure performed with the target access point.

28. An apparatus, comprising:
means for receiving a new access stratum (AS) key for communicating with a wireless device;
means for determining to perform a handover of communications of the wireless device to a target access point; and
means for transmitting a connection reconfiguration message to the wireless device that indicates a key change to the new AS key to complete the handover of communications of the wireless device to the target access point.

29. The apparatus of claim 28, further comprising means for providing the new AS key to the target access point during a handover preparation performed with the target access point.

30. A computer program product, comprising:
a computer-readable medium comprising:
code for causing at least one computer to receive a new access stratum (AS) key related to communicating with a wireless device;
code for causing the at least one computer to determine to perform a handover of communications of the wireless device to a target access point; and
code for causing the at least one computer to transmit a connection reconfiguration message to the wireless device that indicates a key change to the new AS key to complete the handover of communications of the wireless device to the target access point.

31. The computer program product of claim 30, wherein the computer-readable medium further comprises code for causing the at least one computer to provide the new AS key to the target access point during a handover preparation performed with the target access point.

32. An apparatus, comprising:
a new key receiving component that obtains a new access stratum (AS) key for communicating with a wireless device;
a handover determining component that decides to perform a handover of communications of the wireless device to a target access point; and
a key change indicating component that transmits a connection reconfiguration message to the wireless device that indicates a key change to the new AS key to complete the handover of communications of the wireless device to the target access point.

33. The apparatus of claim 32, further comprising a handover preparing component that provides the new AS key to the target access point during a handover preparation performed with the target access point.

34. A method, comprising:
receiving a new access stratum (AS) key and an old AS key related to communicating with a wireless device from a serving access point during a handover preparation; and
performing a random access procedure with the wireless device to participate in a handover related to the handover preparation.

35. The method of claim 34, further comprising:
receiving a connection reconfiguration complete message from the wireless device to complete the handover; and
interpreting the connection reconfiguration complete message based at least in part on the new AS key.

36. The method of claim 34, further comprising receiving a security context based at least in part on the new AS key or the old AS key from the serving access point during the handover preparation.

37. The method of claim 36, wherein the security context is at least in part a short message authentication code for integrity check (MAC-I) related to the new AS key or the old AS key.

38. The method of claim 37, further comprising receiving a connection re-establishment request message from the wireless device following radio link or handover failure that includes the short MAC-I.

39. The method of claim 38, further comprising transmitting a connection re-establishment message to the wireless device that specifies a true value for a key change indicator or a presence of a key stream identifier.

40. The method of claim 39, further comprising:
receiving a connection re-establishment complete message from the wireless device; and
interpreting the connection re-establishment complete message based at least in part on the security context, wherein the security context is based at least in part on the new AS key.

41. The method of claim 36, further comprising activating the new AS key with the wireless device, wherein the security context is based at least in part on the old AS key.

42. The method of claim 41, wherein the activating the new AS key includes performing an intra-cell handover with the wireless device by transmitting a connection reconfiguration message to the wireless device that indicates a key change.

43. A wireless communications apparatus, comprising:
at least one processor configured to:
obtain a new access stratum (AS) key and an old AS key from a serving access point during a handover preparation related to communicating with a wireless device; and
perform a random access procedure with the wireless device to facilitate receiving wireless device communications in a handover from the serving access point related to the handover preparation; and
a memory coupled to the at least one processor.

44. The wireless communications apparatus of claim 43, wherein the at least one processor is further configured to interpret a connection reconfiguration complete message received from the wireless device based at least in part on the new AS key.

45. An apparatus, comprising:
means for receiving a new access stratum (AS) key and an old AS key related to communicating with a wireless device from a serving access point during a handover preparation; and
means for performing a random access procedure with the wireless device to participate in a handover related to the handover preparation.

46. The apparatus of claim 45, wherein the means for performing the random access procedure interprets a connection reconfiguration complete message received from the wireless device based at least in part on the new AS key.

47. A computer program product, comprising:
a computer-readable medium comprising:
code for causing at least one computer to receive a new access stratum (AS) key and an old AS key related to communicating with a wireless device from a serving access point during a handover preparation; and
code for causing the at least one computer to perform a random access procedure with the wireless device to participate in a handover related to the handover preparation.

48. The computer program product of claim 47, wherein the computer-readable medium further comprises:
code for causing the at least one computer to receive a connection reconfiguration complete message from the wireless device to complete the handover; and
code for causing the at least one computer to interpret the connection reconfiguration complete message based at least in part on the new AS key.

49. An apparatus, comprising:
a new key obtaining component that receives a new access stratum (AS) key and an old AS key related to communicating with a wireless device from a serving access point during a handover preparation; and
a device communicating component that performs a random access procedure with the wireless device to participate in a handover related to the handover preparation.

50. The apparatus of claim 49, wherein the device communicating component interprets a connection reconfiguration complete message received from the wireless device based at least in part on the new AS key.
